(19) United States
(12) Patent Application Publication
(10) Pub. No.: US 2009/0169682 A1
(43) Pub. Date: Jul. 2, 2009

(54) Functional Masticatory Material, Method Of Producing The Same And Method Of Using The Same

(75) Inventors: Fumio Okumura, Toyama (JP); Kazuya Kubo, Toyama (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Meiji Pharmaceutical Co., Ltd., Chiyoda-ku, Tokyo (JP)

(21) Appl. No.: 12/089,921

(22) PCT Filed: Oct. 13, 2006
(86) PCT No.: PCT/JP2006/320478

§ 371 Date: Apr. 11, 2008

(30) Foreign Application Priority Data
Oct. 14, 2005 (JP) 2005-299568

(51) Int. Cl. A23L 1/30; A23L 1/28; A23L 1/304; A23L 1/305

(52) U.S. Cl. 426/62; 426/549; 426/74; 426/63

(57) ABSTRACT

Tableting or granulating is conducted using prolamine, wheat gluten and a functional material or materials as raw materials. The functional masticatory product has elasticity and extensibility through inclusion of saliva during mastication, has edibility and has mastication time longer than that of gummi candy. Thus, varied mastication time longer than that of gummi candy can be provided and the functional material or materials can be sufficiently ingested without depending on natures of the same such as water solubility.

### TECHNICAL FIELD

The present invention relates to a functional masticatory product with a functional component or components having physiologic activities helpful for preservation or regaining of health and therapeutic effects on diseases and serving for strengthening a masticatory force, a method of producing the product and a method of using the product.

### BACKGROUND ART

Lifestyle-related diseases such as diabetes, hypertension and hyperlipemia have been increased recently in Japan with westernization of dietary habit and lifestyle. Correlatively with advent of aging society with fewer children, orientation of the public toward health has been enhanced and a notion of self medication that “one's health is protected by oneself” has been widely prevailing. As a result, various functional foods or so-called healthy foods have been placed on the market, and their market size now reaches one trillion yen. Also, mainly due to increase of processed foods and change of preference, young people have strong tendency to ingest soft foods requiring less masticatory force and sugar-rich candies and juices so that increase of dental caries and weakening of teethridges have progressed. Meanwhile, elderly people with diminished masticatory force mainly due to intraoral diseases of teeth and/or teethridges often depend on fluid diets or enteric agents and functions of digestive organs and tongue may be diminished to cause language loss and physical weakness, eventually leading to demented and/or bedridden elderly.

In the context of such social situations, a gummi-candy type masticatory product with various functional components for the purpose of improving masticatory function and preserving/regaining health has been developed (see Reference 1). A functional chewing gum with anti-caries components such as xylitol or catechin has been also developed. Furthermore, an edible functional masticatory product has been developed which is produced by kneading wheat gluten with a gliadin fraction from wheat gluten in moisture state (see Reference 2).

[Reference 1] JP 2002-85008A

[Reference 2] JP 2006-109751A

### SUMMARY OF THE INVENTION

### Problems to be Solved by the Invention

However, the gummi-candy type masticatory product has a problem with insufficiency in mastication time. A piece of gummi jelly with a weight of around 4 g dissolves within a minute during mastication; even when three pieces are ingested all at once, a mastication time is at most about 2 minutes. The edible chewing gum using wheat gluten as a gum base has a masticatory property readily deteriorated with lapse of time because of wet mass kneeled in moisture state. The chewing gum with functional components has a problem with environmental pollution due to discard thereof after mastication since the gum base is an inedible synthesized polymer and also has a problem with insufficient utilization of the functional components since the components are discarded together with the gum base.

Mildewproof treatment such as sugarcoating or membrane-coating is required in the functional masticatory product produced by kneading the gliadin fraction with the wheat gluten in moisture state since it has a water content as high as around 25% by weight and readily goes moldy. Such functional masticatory product having the higher water content is restrictive in kind of functional components used since lactic acid bacteria and enzymes readily affected by moisture cannot be used. Further, it has been ascertained that elasticity of such functional masticatory product upon mastication is lowered after storage at 40° C. for one month. In a case of a functional masticatory product which does not become inactive over 15 minutes after beginning of mastication, water-insoluble solid functional components are difficult to ingest for some people such as the elderly, children and females because of difficulty in swallowing. A functional masticatory product in the form of wet mass has a problem with substantially high production cost since great power is required for kneading and rolling, and thus ordinary agitators and rolling machines are inapplicable and special production machines are needed.

The invention was made in view of the above and has its object to provide a functional masticatory product which may have varied mastication time longer than that of gummi candy, prevents discard thereof after mastication and allows a functional material or materials with physiologic activities helpful for preserving/regaining health and therapeutic effects on diseases to be ingested without depending on natures of the functional material or materials such as water solubility, a method of producing the product and a method of using the product.

### Means or Measures for Solving the Problems

The inventor extensively studied for solution of the above problems to find out that a mixture of polyamine, wheat gluten and/or polyphenol may be added and mixed with various functional components and tableted or granulated into a functional masticatory product which has appropriate elasticity and aggregateness through inclusion of saliva during mastication to serve for strengthening a masticatory force and which is edible for reliable ingestion of the functional components and may be useful as a formulation capable of being dosed without water, thus completing the invention.

Thus, claim 1 of the invention is directed to a functional masticatory product which is prepared from prolamine, wheat gluten and a functional material or materials through tableting or granulating, said product having elasticity and extensibility through inclusion of saliva during mastication, said product being edible and having mastication time longer than that of gummi candy.

Claim 2 of the invention is directed to the fact that, in claim 1, a weight ratio of the prolamine to the wheat gluten is in a range of 8:2-2:8.

Claim 3 of the invention is directed to a functional masticatory product which is prepared from prolamine, polyphenol and a functional material or materials through tableting or granulating, said product having elasticity and extensibility through inclusion of saliva during mastication, said product being edible and having mastication time longer than that of gummi candy, the elasticity and extensibility being improved by the polyphenol.

Claim 4 of the invention is directed to a functional masticatory product which is prepared from prolamine, wheat gluten, polyphenol and a functional material or materials through tableting or granulating, said product having elasticity and extensibility through inclusion of saliva during mastication, said product being edible and having mastication time longer than that of gummi candy, the elasticity and extensibility being improved by the polyphenol.

Claim 5 of the invention is directed to the fact that, in claim 4, a weight ratio of the prolamine to the wheat gluten is in a range of 9.9:0.1-2:8.

Claim 6 of the invention is directed to the fact that, in claim 3 or 4, the polyphenol is combined by 1-20% to a total amount of the prolamine and wheat gluten.

Claim 7 of the invention is directed to the fact that, in claim 1, 3 or 4, the prolamine is at least one selected from a group consisting of wheat gliadin, maize zein and barley hordein.

Claim 8 of the invention is directed to the fact that, in claim 1, 3 or 4, the functional material or materials are at least one selected from a group consisting of polyphenol such as tea catechin, epigallocatechin gallate, grape seed proanthocyanidin and French maritime pine bark extract, sesame lignan, astaxanthin derived from Hematococcus algae, γ-aminobutyric acid, hypotensive peptides, xylitol, mastic (mastiche) extract, propolis, funoran, galenical extract from nutmeg and tansy, mushroom extract of Agaricus blazei Murrill, Meshimakobu (Phellinus linteus) and Yamabushitake (Hericium erinaceum), fucoidan, heat-treated lactic acid bacteria powder, lactoferrin, isoflavone, ginkgo leaf (Ginkgo Biloba) extract, Vinca minor extract, phosphatidyl serine, fish-derived highly unsaturated fatty acids such as arachidonic acid, EPA and DHA, chili pepper powder, raspberry ketone, capsiate, coenzyme Q-10, α-lipoic acid, carnitine chloride, citrus extract, salacia extract, Gymnema sylvestre extract, white kidney bean extract, mulberry leaf extract, vitamins, green and yellow vegetable extract, royal jelly, minerals such as calcium compounds, magnesium compounds, zinc yeast and iron drugs, galenical extract for nutritional fortification, ceramides, hyaluronic acid, cysteine, cystine, champignon extract, sodium copper chlorophyllin, sodium iron-chlorophyllin, lactic acid bacteria, inulin, fructo-oligosaccharide, galacto-oligosaccharide, xylo-oligosaccharide, nicotine, caffeine and theanine.

Claim 9 of the invention is directed to a fact that, in claim 1, 3 or 4, the functional material or materials are at least one selected from a group consisting of polyphenol including apple proanthocyanidin, cassis extract and blueberry extract, cyanidin glycoside derived from black beans, curcumin, tetrahydrocurcumin, policosanol, octacosanol, collagen, phytic acid, aspirin, acetaminophen, chloropheniramine dl-maleate, dihydrocodeine phosphate, methylephedrine di-chloride, tipepidine citrate, lysozyme chloride, senega fluid extract, caffeine, allylisopropylacetyl urea, cetylpyridinium chloride, chlorhexidine hydrochloride, potassium cresolsulfonate, sakura bark, licorice, l-menthol and sodium azulenesulfonate.

Claim 10 of the invention is directed to the fact that, in claim 3 or 4, the polyphenol is at least one selected from a group consisting of catechins, epigallocatechin gallate, proanthocyanidine, anthocyanin, flavonol, isoflavone, sesaminol, quercetin, curcumin and persimmon tannin.

Claim 11 of the invention is directed to the fact that, in claim 1, 3 or 4, proteolytic enzyme agent is combined by 1-40%.

Claim 12 of the invention is directed to the fact that, in claim 11, the proteolytic enzyme agent is selected from a group consisting of proteolytic enzymes derived from filamentous fungi, bacteria, basidiomycete, actinomycete and plants.

Claim 13 of the invention is directed to the fact that, in claim 1, 3 or 4, disintegrant aid is combined by 5-40%.

Claim 14 of the invention is directed to the fact that, in claim 13, the disintegrant aid is selected from a group consisting of proteins such as gelatin, sodium caseinate, calcium caseinate and collagen, polysaccharides such as carageenan, xanthan gum, gellan gum, tragacanth, agar, sodium carboxymethylcellulose, calcium carboxycellulose and sodium alginate, polyvinyl pyrrolidone and glycerin monofatty acid ester.

Thus, according to claim 1 of the invention, the tableting or granulating is conducted using the prolamine, the wheat gluten and the functional material or materials as raw materials and the product has elasticity and extensibility through inclusion of saliva during mastication, so that it is possible to bring about varied mastication time longer than that of gummi candy. Because of edibility due to use of the prolamine, the wheat gluten and the functional material or materials as the raw materials, the functional material or materials containing the functional components can be sufficiently ingested without depending on natures of the functional material or materials such as water solubility to contribute to preservation, promotion or regaining of health, and the discard after mastication like chewing gums can be prevented to inhibit environmental pollution. After eaten with mastication, the functional masticatory product is completely digested in digestive organs so that the functional material or materials can be reliably absorbed not only for preservation, promotion or regaining of health but also for treatment of diseases. The functional masticatory product, which has edibility, may be useful as a formulation capable of being dosed without water.

The wheat gluten used in the invention is powdery wheat protein so called active or vital gluten and is composed, in about 80% of a total amount, of glutenin having a molecular weight of about 200,000 to several millions and gliadin having a molecular weight of about 30,000 to 80,000, the glutenin and gliadin being contained in equivalent amounts.

According to claim 3 of the invention, tableting or granulating is conducted using the prolamine, the polyphenol and the functional material or materials as raw materials and the product has elasticity and extensibility through inclusion of saliva during mastication and the elasticity and extensibility are improved by the polyphenol, so that it is possible to bring about varied mastication time longer than that of gummi candy. Because of edibility due to use of the prolamine, the polyphenol and the functional material or materials as raw materials, the functional material or materials containing the functional components can be sufficiently ingested without depending on natures of the functional material or materials such as water solubility for preservation, promotion or regaining of health, and the discard after mastication like chewing gums can be prevented to inhibit environmental pollution. After eaten with mastication, the functional masticatory product is completely digested in digestive organs so that the functional material or materials can be reliably absorbed not only for preservation, promotion or regaining of health but also for treatment of diseases. The functional masticatory product, which has edibility, may be useful as a formulation capable of being dosed without water.

According to claim 4 of the invention, tableting or granulating is conducted using the prolamine, the wheat gluten, the polyphenol and the functional material or materials as raw materials and the product has elasticity and extensibility through inclusion of saliva during mastication and the elasticity and extensibility are improved by the polyphenol, so that it is possible to bring about varied mastication time longer than that of gummi candy. Because of edibility due to use of the prolamine, the wheat gluten, the polyphenol and the functional material or materials as raw materials, the functional material or materials containing the functional components can be sufficiently ingested without depending on natures of the functional material or materials such as water solubility for preservation, promotion or regaining of health, and the discard after mastication like chewing gums can be prevented to inhibit environmental pollution. After eaten with mastication, the functional masticatory product is completely digested in digestive organs so that the functional material or materials can be reliably absorbed not only for preservation, promotion or regaining of health but also for treatment of diseases. The functional masticatory product, which has edibility, may be useful as a formulation capable of being dosed without water.

Moreover, according to claim 1, 3 or 4 of the invention, a functional masticatory product with low moisture content can be obtained through tableting or granulating commonly used in production of pharmaceuticals and/or healthy foods in such a manner that raw material powder is directly tableted, that granulated powder is tableted which is obtained through dry granulation of raw material powder or that granulated powder is tableted which is obtained through granulation and drying of raw material powder in a wet granulating method such as a fluidized bed granulating/drying method. Thus, differently from a functional masticatory product with high moisture content in the form of wet mass, the functional masticatory product with low water activity according to the invention requires no mildewproof treatment with sugarcoating or film coating and requires no special equipments for kneading and rolling. The functional masticatory product of the invention, which is produced by the production process of granulating, drying and/or tableting with high versatility, can be substantially reduced in production cost.

The functional masticatory product with low moisture content of the invention is produced as tablets or granulated powder using production equipments such as a granulator, a drier and/or a tableting machine commonly used in a pharmaceutical industry and/or a healthy food industry. When the functional masticatory product with low moisture content is produced in a dry granulating method, mixed raw material powder is granulated by a dry granulator without adding water into granulated powder which may be tableted when tablets are to be produced. In a fluidized bed granulating/drying method which is one of wet granulating methods, raw material powder is sprayed with an aqueous solution of binder such as α-starch and is granulated and dried into granulated powder which may be tableted when tablets are to be produced. In the wet granulating method, cleaning of the production equipments is troublesome since gliadin, when wetted, becomes viscous to have adhesivity. Thus, a dry granulating method, which requires no water as binder solution, is particularly preferable as the granulating method for the functional masticatory product of the invention. Meanwhile, when a functional masticatory product with high moisture content in the form of wet mass is produced, water is added to the raw material powder of gliadin and the like by 15-25% upon kneading, so that the wet mass becomes extremely viscous and involves a large load during the kneading, and thus a large-scale and high-powered kneader is required as is used for production of chewing gum base. Further, in order to thinly stretch and cut such wet mass, special equipments such as two- or three-high rolling rollers and cutting rollers are required as are used for production of chewing gum. When tablets are produced by tableting the granulated powder obtained by hot-air drying and pulverizing the functional masticatory product with high moisture content in the form of wet mass, a drying operation takes a long time because of high viscosity of the wet mass and moldability of the product upon tableting is poor because of hardness of the obtained granulated powder, which make it difficult to produce the tablets efficiently and, of course, results in substantial increase in production cost. Meanwhile, where the functional masticatory product with high moisture content in the form of wet mass is freeze-dried, a drying operation takes as long as more than two days and is extremely troublesome in that as many as hundreds of thousand of small wet mass plates about 10 mm square are housed in a lyophilizer. Thus, the production cost is remarkably increased in comparison with the method of production of the invention which can ensure the production of more than one million tablets per day.

According to the invention, even lactic acid bacteria and enzyme readily affected by moisture may be combined since the tableting or granulating is conducted under a condition of low moisture activity. In a formulation with a water insoluble functional component, e.g., an inorganic compound such as dolomite, a base material ratio of prolamine/wheat gluten and/or an amount of polyphenol to be combined is controlled to have mastication time of several minutes to about 10 minutes; alternatively, the claimed masticatory product may be adjusted to be smaller size to have a weight of 300-400 mg per tablet, which allows the tablet to be readily swallowed. Thus, functional components contained in the masticatory product can be ingested reliably and sufficiently.

As recited in claim 2 of the invention, when in claim 1 the weight ratio of the prolamine to the wheat gluten is in a range of 8:2 to 2:8, the mastication time can be properly prolonged to increase a number of mastication, and the functional material or materials can be sufficiently ingested without discarding the same because of edibility, further appropriately contributing to preservation, promotion or regaining of health. Complete digestion of the functional masticatory product brings about reliable absorption of the functional material or materials, further appropriately contributing not only to preservation, promotion or regaining of health but also treatment of diseases. As to the weight ratio of the prolamine to the wheat gluten being 8:2, the proportion of the wheat gluten less than this is unfavorable because of resulting deteriorated elasticity and shortage of mastication time. As to the weight ratio of the prolamine to the wheat gluten being 2:8, the proportion of the wheat gluten more than this is unfavorable because of resultant extremely deteriorated extensibility, leading to insufficient chewing-gum-like toughness in mastication, poor moldability, lower tablet hardness and unmanageability. In order to assure sufficient chewing-gum-like toughness in mastication of the claimed functional masticatory product, it is preferable that a combined base material amount of the prolamine and the wheat gluten is at least around 40% by weight.

As recited in claim 5 of the invention, when in claim 4 the weight ratio of the prolamine to the wheat gluten is in a range of 9.9:0.1-2:8, the mastication time can be properly prolonged to increase a number of mastication, and the functional material or materials can be sufficiently ingested without discarding the same because of edibility, further appropriately contributing to preservation, promotion or regaining of health. Complete digestion of the functional masticatory product brings about sure absorption of the functional material or materials, further appropriately contributing not only to preservation, promotion or regaining of health but also to treatment of diseases. As to the weight ratio of the prolamine to the wheat gluten being 2:8, the proportion of wheat gluten more than this is unfavorable because of resultant extremely deteriorated elasticity, leading to insufficient chewing-gum-like toughness in mastication, poor moldability, lower tablet hardness and unmanageability. In order to assure sufficient chewing-gum-like toughness in the claimed functional masticatory product, it is preferable that a combined base material amount of the prolamine and the wheat gluten is at least around 40% by weight.

As recited in claim 6 of the invention, when in claim 3 or 4 the polyphenol are combined by 1-20% to a total amount of the prolamine and the wheat gluten, the mastication time can be properly prolonged to increase a number of mastication, and the functional material or materials can be sufficiently ingested without discarding the same because of edibility, further appropriately contributing to preservation, promotion or regaining of health. Complete digestion of the functional masticatory product brings about reliable absorption of the functional material or materials, further appropriately contributing not only to preservation, promotion or regaining of health but also to treatment of diseases. The proportion of the polyphenol less than 1% is unfavorable because of resultant deteriorated elasticity and too shortened mastication time. The proportion of the polyphenol more than 20% is unfavorable because of resultant increased bitterness and increased production cost.

As recited in claim 7 of the invention, when in claim 1, 3 or 4 the prolamine are at least one selected from a group consisting of wheat gliadin, maize zein and barley hordein, the mastication time can be appropriately prolonged to increase a number of mastication, and the functional material or materials can be sufficiently ingested without discarding the same because of edibility to thereby further appropriately contributing to preservation, promotion or regaining of health. Complete digestion of the functional masticatory product brings about reliable absorption of the functional material or materials, further appropriately contributing not only to preservation, promotion or regaining of health but also to treatment of diseases. The prolamine may be protein such as rye gliadin, but wheat gliadin is most inexpensive, readily available and is superior in moldability upon tableting to maize zein and barley hordein. Thus, use of wheat gliadin is particularly preferable.

As recited in claim 8 of the invention, when in claim 1, 3 or 4 the functional material or materials are at least one selected from a group consisting of polyphenol including tea catechin, epigallocatechin gallate, grape seed proanthocyanidine and France maritime pine bark extract, sesame lignans, astaxanthine derived from Hematococcus algae, γ-aminobutyric acid, hypotensive peptides, xylitol, mastic (mastiche) extract, propolis, funoran, galenical extract from nutmeg and tansy, mushroom extract of Agaricus blazei Murrill, Meshimakobu (Phellinus linteus) and Yamabushitake (Hericium erinaceum), fucoidan, heat-treated lactic acid bacterium powder, lactoferrin, isoflavone, ginkgo leaf (Ginkgo Biloba) extract, Vinca minor extract, phosphatidyl serine, fish-derived highly unsaturated fatty acids such as arachidonic acid, EPA and DHA, chili pepper powder, raspberry ketone, capsiate, coenzyme Q-10, α-lipoic acid, carnitine chloride, citrus extract, salacia extract, Gymnema sylvestre extract, white kidney bean extract, mulberry leaf extract, vitamins, green and yellow vegetable extract, royal jelly, minerals such as calcium compounds, magnesium compounds, zinc yeast and iron drugs, galenical extract for nutritional fortification, ceramides, hyaluronic acid, cysteine, cystine, champignon extract, sodium copper chlorophylin, sodium iron chlorophylin, lactic acid bacteria, inulin, fructo-oligosaccharide, galacto-oligosaccharide, xylo-oligosaccharide, nicotine, caffeine and theanine, selection in type of the functional material or materials makes it possible to utilize the product as therapeutic agent or preventive food for specified diseases such as flu, intraoral diseases or lifestyle-related diseases, to utilize the product as functional food targeting a specified age group or gender, e.g., as food for females who are oriented to a diet or interested in whitening and beautiful skin, to utilize the product as food for the elderly who wants to inhibit declines of bones, immunity and/or memory or to utilize the product as food for children and/or the young who want to prevent dental caries and strengthen teethridges. Thus, to eat the functional masticatory product according to the invention combined with functional components depending on diseases to be prevented or treated, generation or gender makes it possible to further contribute to preservation, promotion or regaining of health or treatment of diseases.

As recited in claim 9 of the invention, when in claim 1, 3 or 4 the functional material or materials are at least one selected from a group consisting of polyphenol including apple proanthocyanidin, cassis extract and blueberry extract, cyanidin glycoside derived from black beans, curcumin, tetrahydrocurcumin, policosanol, octacosanol, collagen, phytic acid, aspirin, acetaminophen, chlorpheniramine dl-maleate, dihydrocodeine phosphate, methylephedrine di-chloride, tipepidine citrate, lysozyme chloride, senega fluid extract, caffeine, allylisopropylacetyl urea, cetylpyridinium chloride, chlorhexidine hydrochloride, potassium cresolsulfonate, sakura bark, licorice, 1-menthol and sodium azulenesulfonate, selection in type of the functional material or materials makes it possible to utilize the product as therapeutic agent or preventive food for specified diseases such as flu, intraoral diseases or lifestyle-related diseases, to utilize the product as functional food targeting a specified age group or gender, e.g., as food for females who are oriented to the diet or interested in whitening and beautiful skin, to utilize the product as food for the elderly who wants to inhibit declines of bones, immunity and memory or to utilize the product as food for children and the young who want to prevent dental caries and strengthen teethridges. Thus, to eat the functional masticatory product according to the invention combined with functional components depending upon diseases to be prevented or treated, generation or gender makes it possible to further contribute to preservation, promotion or regaining of health or treatment of diseases.

More specifically, among the functional materials, useful as antioxidants are polyphenols including tea catechin, epigallocatechin gallate, grape seed proanthocyanidine, apple proanthocyanidine, French maritime pine bark extract, cassis extract and blueberry extract, sesame lignans, cyanidin glycoside derived from black beans, curcumin, tetrahydrocurcumin, astaxanthine derived from Hematococcus algae, coenzyme Q-10 and α-lipoic acid. Policosanol is useful as cholesterol reducer or platelet aggregation inhibitor for prevention or regaining from lifestyle-related diseases. Useful for improving hypertension are γ-aminobutyric acid and hypotensive peptides, which are functional amino acids. Components useful for preventing intraoral diseases are galenical extract of nutmeg and tansy and phytic acid in addition to xylitol, mastic (mastiche) extract, propolis and funoran. The mastic (mastiche) extract are useful components for eliminating Helicobacter pylori involved in occurrence of stomach cancer and gastritis. Components which augment immunity are mushroom extract of Agaricus blazei Murrill, Meshimakobu (Phellinus linteus) and Yamabushitake (Hericium erinaceum), fucoidan, heat-treated lactic acid bacterium powder and lactoferrin. Components useful for dementia and menopausal disorders are isoflavone, ginkgo (Ginkgo Biloba) leaf extract, Vinca minor extract, phosphatidyl serine, fish-derived highly unsaturated fatty acids such as arachidonic acid, EPA and DHA. Useful components as anti-obesity substances are chili pepper powder, raspberry ketone, capsiate, coenzyme Q-10, carnitine chloride, citrus extract, salacia extract, Gymnema sylvestre extract, white kidney bean extract, tea catechin, mulberry leaf extract and octacosanol. Frequently used as nutritional fortification components are vitamins, green and yellow vegetable extract, royal jelly, minerals such as calcium compounds, magnesium compounds, zinc yeast and iron drugs and galenical extract for nutritional fortification. Ceramides, collagen, hyaluronic acid, cysteine and cystine are useful components for whitening and beautiful skin. Commonly used as odor eliminating components are champignon extract, sodium copper chlorophylin, sodium iron chlorophylin, tea catechin and apple phenon. Useful as antiflatuent components are lactic acid bacteria, inulin, fructo-oligosaccharide, galacto-oligosaccharide and xylo-oligosaccharide. Nicotine is used as active component of anti-smoking aids. Caffeine and theanine are useful as components for sleep-averting and relax. Components useful for treatment of various symptoms of flu, cough suppression/expectorant, lowering of fever/pain relief and oral throat inflammation are aspirin, acetaminophen, chlorpheniramine dl-maleate, dihydrocodeine phosphate, methylephedrine dl-chloride, tipepidine citrate, lysozyme chloride, senega fluid extract, caffeine, allylisopropylacetyl urea aspirin, cetylpyridinium chloride, chlorhexidine hydrochloride, potassium cresolsulfonate, sakura bark, licorice, 1-menthol and sodium azulenesulfonate.

Other functional materials may be employed with no particular limitation and may include antioxidants and amino acids useful for lifestyle-related diseases such as diabetes, hypertension and hyperglycemia, components useful for intraoral diseases such as periodontal diseases, components which augment immunity, components useful for dementia and menopausal disorders, components useful for viral diseases, anti-obesity substances, nutritional fortification components and components for whitening and beautiful skin. Additionally, herbs and glycine which is a hypnosis inducing component may be used.

As recited in claim 10 of the invention, when in claim 3 or 4 the polyphenol is at least one selected from a group consisting of catechins, epigallocatechin gallate, proanthocyanidine, anthocyanin, flavonol, isoflavone, sesaminol, quercetin, curcumin and persimmon tannin, the mastication time can be appropriately prolonged to increase a number of mastication and the functional material or materials can be sufficiently ingested without discarding the same because of edibility to thereby further contribute to preservation, promotion or regaining of health and simultaneously to treatment of diseases.

As recited in claim 11 of the invention, when in claim 1, 3 or 4 proteolytic enzyme agent is combined by 1-40%, the functional masticatory product becomes readily loosenable because of resultant reduced elasticity and aggregateness due to the proteolytic enzyme agent, so that the mastication time can be controlled to be shorter for easier eating. Thus, the functional masticatory material or materials can be easily ingested without discarding the same to thereby further appropriately contribute to preservation, promotion or regaining of health and simultaneously to treatment of diseases.

As recited in claim 12 of the invention, when in claim 11 the proteolytic enzyme agent is selected from a group consisting of proteolytic enzymes derived from filamentous fungi, bacteria, basidiomycete, actinomycetes and plants, the functional masticatory product becomes readily loosenable because of resultant reduced elasticity and aggregateness, resulting in further facilitation of ease in eating.

As recited in claim 13 of the invention, when in claim 1, 3 or 4 disintegrant aid is combined by 5-40%, the functional masticatory product becomes readily loosenable because of resultant reduced elasticity and aggregateness due to the disintegrant aid, so that the mastication time can be controlled to be shorter for easier eating. Thus, the functional material or materials can be easily ingested without discarding the same to thereby further appropriately contribute to preservation, promotion or regaining of health and simultaneously to treatment of diseases.

As recited in claim 14 of the invention, when in claim 13 the disintegrant aid is selected from a group consisting of proteins such as gelatin, sodium caseinate, potassium casein and collagen, polysaccharides such as carageenanan, xanthan gum, gellan gum, tragacanth, agar, sodium carboxymethylcellulose, calcium carboxycellulose and sodium alginate, polyvinyl pyrrolidone and glycerine monofatty acid ester, the functional masticatory product becomes readily loosenable because of resultant reduced elasticity and aggregateness, resulting in further facilitation of ease of eating.

Next, a method of producing a functional masticatory product of the invention will be described.

Claim 15 of the invention is directed to a method of producing a functional masticatory product comprising conducting tableting or granulating using prolamine, wheat gluten and a functional material or materials as raw materials.

Claim 16 of the invention is directed to the fact that, in claim 15, a weight ratio of the prolamine to the wheat gluten is in a range of 8:2-2:8.

Claim 17 of the invention is directed to a method of producing a functional masticatory product comprising conducting tableting or granulating using prolamine, polyphenol and a functional material or materials as raw materials.

Claim 18 of the invention is directed to a method of producing a functional masticatory product comprising tableting or granulating using prolamine, wheat gluten, polyphenol and a functional material or materials as raw materials.

Claim 19 of the invention is directed to the fact that, in claim 18, a weight ratio of the prolamine to the wheat gluten is in a range of 9.9:0.1-2:8.

Claim 20 of the invention is directed to the fact that, in claim 17 or 18, the polyphenol is combined by 1-20% to a total amount of the prolamine and wheat gluten.

Claim 21 of the invention is directed to the fact that, in claim 15, 17 or 18, proteolytic enzyme agent is combined by 1-40%.

Claim 22 of the invention is directed to the fact that, in claim 15, 17 or 18, disintegrant aid is combined by 5-40%.

When a functional masticatory product in the form of tablets is produced according to claim 15 or 16 of the invention, firstly prepared is base raw material powder composed of prolamine and wheat gluten in a combination ratio of 8:2 to 2:8. Then, the base raw material powder is added with the functional material or materials, sweetener, flavor and lubricant and is directly tableted. Alternatively, the base raw material powder is mixed with the functional material or materials, sweetener, flavor and lubricant and is granulated through a dry granulating method into granulated powder which is tableted into tablets. Alternatively, the base raw material powder is mixed with the function material or materials and sweetener and is granulated and dried through a wet granulating method such as a fluidized bed granulating/drying method using starch glue as a binder, the resultant dried granulated powder being added with flavor and lubricant and being tableted. Meanwhile, when the functional masticatory product in the form of granulated powder is produced, firstly prepared is base raw material powder composed of prolamine and wheat gluten in the combination ratio of 8:2 to 2:8. Then, the base raw material powder is added with functional material or materials, sweetener, flavor and lubricant and is granulated in a dry manner. Alternatively, the base raw material power is mixed with the functional material or materials and sweetener and is granulated and dried through a wet granulating method such as a fluidized bed granulating/drying method using starch glue as a binder, the resultant dried granulated powder being added with flavor. The production process of the functional masticatory product in the form of tablets or granulated powder may be that commonly used in producing pharmaceuticals or healthy foods. That is, common formulating machines such as a dry granulator, a fluidized bed granulator/drier, a tumbling fluidized granulator and a tableting machine may be used.

Thus, according to claim 15 or 16 of the invention, a functional masticatory product with low moisture content can be produced by very simple operations such that base raw material powder of prolamine and wheat gluten is added with a functional material or materials and the like and common production techniques such as granulating, drying and tableting are given thereto. Thus, differently from a functional masticatory product with high moisture content in the form of wet mass, the functional masticatory product with low moisture activity according to the invention requires no mildewproof treatment with sugarcoating or film coating and requires no special instruments for kneading and rolling. The functional masticatory product of the invention, which is produced by the production process of granulating, drying and/or tableting with high versatility, can be substantially reduced in production cost.

The functional masticatory product with low moisture content of the invention is produced as the tablets or granulated powder using production equipments such as a granulator, a drier and/or a tableting machine commonly used in a pharmaceutical industry and/or a healthy food industry. When the functional masticatory product with low moisture content is produced in a dry granulating method, mixed raw material powders is granulated by a dry granulator without adding water into granulated powder which may be tableted when tablets are to be produced. In a fluidized bed granulating/drying method which is one of wet granulating methods, raw material powder is sprayed with an aqueous solution of binder such as α-starch and is granulated and dried into granulated powder which may be tableted when tablets are to be produced. In the wet granulating method, cleaning of the production equipments is troublesome since gliadin, when wetted, becomes viscous to have adhesivity. Thus, a dry granulating method, which requires no water as binder solution, is particularly preferable as the granulating method for the functional masticatory product of the invention. Meanwhile, when a functional masticatory product with high moisture content in the form of wet mass is produced, water is added to the raw material powder of gliadin and the like by 15-20% upon kneading, so that the wet mass becomes extremely viscous and involves a large load during kneading, and thus a large-scale and high-powered kneader is required as is used for production of chewing gum base. Furthermore, in order to thinly stretch and cut such wet mass, special equipments such as two- or three-high rolling rollers and cutting rollers are required as are used for production of chewing gum. When tablets are produced by tableting the granulated powder obtained by hot-air drying and pulverizing the functional masticatory product with high moisture content in the form of wet mass, a drying operation takes a long time because of high viscosity of the wet mass and moldability of the product is poor upon tableting because of hardness in the obtained granulated powder, which makes it difficult to produce the tablets efficiently and, of course, results in substantial increase in production cost. Meanwhile, where the functional masticatory product with high moisture content in the form of wet mass is freeze-dried, a drying operation takes as long as more than two days and is extremely troublesome in that as many as hundreds of thousands of small wet mass plates about 10 mm square are housed in a lyophilizer. Thus, the production cost is remarkably increased compared with the method of production of the invention which can ensure the production of more than one million tablets per day.

According to the invention, even lactic acid bacteria and/or enzyme readily affected by moisture may be combined since the tableting or granulating is conducted under a condition of low moisture activity. In a formulation with a water insoluble solid functional component, e.g., an inorganic compound such as dolomite, a base material ratio of prolamine/wheat gluten and/or a combined amount of polyphenol is controlled to have mastication time of several minutes to about 10 minutes; alternatively, the claimed masticatory product may be adjusted to be smaller size to have a weight of 300-400 mg per tablet, which allows the tablets to be readily swallowed. Thus, functional components contained in the masticatory product can be ingested reliably and sufficiently.

When a functional masticatory product in the form of tablets is produced according to claim 17 or 20 of the invention, firstly prepared is base raw material powder composed of prolamine and polyphenol, the polyphenol being combined by 1-20% relative to the prolamine. Then, the base raw material powder is added with the functional material or materials, sweetener, flavor, lubricant and the like and is directly tableted. Alternatively, the base raw material powder is mixed with the functional material or materials, sweetener, flavor, lubricant and the like and is granulated through a dry granulating method into granulated powder which is tableted into tablets. Alternatively, the base raw material powder is mixed with the functional material or materials and sweetener and is granulated and dried through a wet granulating method such as a fluidized bed granulating/drying method using starch glue as a binder, the resultant dried granulated powder being added with flavor and lubricant and being tableted. Meanwhile, when the functional masticatory product in the form of granulated powder is produced, similarly, firstly prepared is base raw material powder composed of prolamine and polyphenol, the polyphenol being combined by 1-20% relative to the prolamine. Then, the base raw material powder is added with the functional material or materials, sweetener, flavor, lubricant and the like and is granulated in a dry manner. Alternatively, the base raw material powder is mixed with the functional material or materials, sweetener and the like and is granulated and dried through a wet granulating method such as a fluidized bed granulating/drying method using starch glue as a binder, the resultant dried granulated powder being added with flavor. The production process of the functional masticatory product in the form of tablets or granulated powder may be that commonly used in producing pharmaceuticals or healthy foods. That is, common formulating machines such as a dry granulator, a fluidized bed granulator/drier, a tumbling fluidized granulator and a tableting machine may be used.

Thus, according to claim 17 or 20 of the invention, a functional masticatory product with low moisture content can be produced by very simple operations such that base raw material powder of prolamine and polyphenol is added with the functional material or materials and the like and common production techniques such as granulating, drying and tableting are given thereto. Thus, differently from a functional masticatory product with high moisture content in the form of wet mass, the functional masticatory product with low moisture activity according to the invention requires no mildewproof treatment with sugarcoating or film coating and requires no special instruments for kneading and rolling. The functional masticatory product of the invention, which is produced by the production process of granulating, drying and/or tableting with high versatility, can be substantially reduced in production cost.

The functional masticatory product with low moisture content of the invention is produced as the tablets or granulated powder using production equipments such as a granulator, a drier and/or a tableting machine commonly used in a pharmaceutical industry and/or a healthy food industry. When the functional masticatory product with low moisture content is produced in a dry granulating method, mixed raw material powder is granulated by a dry granulator without adding water into granulated powder which may be tableted when tablets are to be produced. In a fluidized bed granulating/drying method which is one of wet granulating methods, raw material powder is sprayed with an aqueous solution of binder such as α-starch is granulated and dried into granulated powder which may be tableted when tablets are to be produced. In the wet granulating method, cleaning of the production equipments is troublesome since gliadin, when wetted, becomes viscous to have adhesivity. Thus, a dry granulating method, which requires no water as binder solution, is particularly preferable as the granulating method for the functional masticatory product of the invention. Meanwhile, when a functional masticatory product with high moisture content in the form of wet mass is produced, water is added to the raw material power of gliadin and the like by 15-25% upon kneading, so that the wet mass becomes extremely viscous and involves a large load during kneading, and thus a large-scale and high-powered kneader is required as is used for production of chewing gum base. Furthermore, in order to thinly stretch and cut such wet mass, special equipments such as two- or three-high rolling rollers and cutting rollers are required as are used for production of chewing gum. When tablets are produced by tableting the granulated powder obtained by hot-air drying and pulverizing the functional masticatory product with high moisture content in the form of wet mass, a drying operation takes a long time because of high viscosity of the wet mass and moldability of the product is poor upon tableting because of hardness in the obtained granulated powder, which makes it difficult to produce the tablets efficiently and, of course, results in substantial increase in production cost. Meanwhile, where the functional masticatory product with high moisture content in the form of wet mass is freeze-dried, a drying operation takes as long as more than two days and is extremely troublesome in that as many as hundreds of thousands of small wet mass plates about 10 mm square are housed in a lyophilizer. Thus, the production cast is remarkably increased compared with the method of production of the invention which can ensure the production of more than one million tablets per day.

According to the invention, even lactic acid bacteria and/or enzyme readily affected by moisture may be combined since the tableting or granulating is conducted under a condition of low moisture activity. In a formulation with a water insoluble solid functional component, e.g., an inorganic compound such as dolomite, a combined amount of polyphenol is controlled to have mastication time of several minutes to about 10 minutes; alternatively, the claimed masticatory product may be adjusted to be smaller size to have a weight of 300-400 mg per tablet, which allows the tablets to be readily swallowed. Thus, functional components contained in the masticatory product can be ingested reliably and sufficiently.

When the functional masticatory product in the form of tablets is prepared according to claim 18, 19 and 20 of the invention, firstly prepared is base raw material powder composed of prolamine, wheat gluten and polyphenol with a weight ratio of the prolamine to the wheat gluten being in a range of 9.9:0.1-2:8, the polyphenol being combined by 1-20% to a total amount of the prolamine and the wheat gluten. Then, the base raw material powder is added with the functional material or materials, sweetener, flavor, lubricant and the like and is directly tableted. Alternatively, the base raw material powder is mixed with the functional material or materials, sweetener, flavor, lubricant and the like and is granulated through a dry granulating method into granulated powder which is tableted into tablets. Alternatively, the base raw material powder is mixed with the functional material or materials and sweetener and is granulated and dried through a wet granulating method such as a fluidized bed granulating/drying method using starch glue as a binder, the resultant dried granulated powder being added with flavor and lubricant and being tableted. Meanwhile, when the functional masticatory product in the form of granulated powder is produced, similarly, firstly prepared is base raw material powder composed of prolamine, wheat gluten and polyphenol with the weight ratio of the prolamine to the wheat gluten being in a range of 9.9:0.1-2:8, the polyphenol being combined by 1-20% to a total amount of the prolamine and the wheat gluten. Then, the base raw material powder is added with the functional material or materials, sweetener, flavor, lubricant and the like and is granulated in a dry manner. Alternatively, the base raw material powder is mixed with the functional material or materials, sweetener and the like and is granulated and dried through a wet granulating method such as a fluidized bed granulating/drying method using starch glue as a binder, the resultant dried granulated powder being added with flavor. The production process of the functional masticatory product in the form of tablets or granulated powder may be that commonly used in producing pharmaceuticals or healthy foods. That is, common formulating machines such as a dry granulator, a fluidized bed granulator/drier, a tumbling fluidized granulator and tableting machine may be used.

Thus, according to claim 18, 19 or 20 of the invention, a functional masticatory product with low moisture content can be produced by very simple operations such that base raw material powder of prolamine, wheat gluten and polyphenol is added with the functional material or materials and the like and common production techniques such as granulating, drying and tableting are given thereto. Thus, differently from a functional masticatory product with high moisture content in the form of wet mass, the functional masticatory product with low moisture activity according to the invention requires no mildewproof treatment with sugarcoating or film coating and requires no special instruments for kneading and rolling. The functional masticatory product of the invention, which is produced by the production process of granulating, drying and/or tableting with high versatility, can be substantially reduced in production cost.

The functional masticatory product with low moisture content of the invention is produced as tablets or granulated powder using production equipments such as a granulator, a drier and/or a tableting machine commonly used in a pharmaceutical industry and/or a healthy food industry. When the functional masticatory product with low moisture content is produced in a dry granulating method, mixed raw material powder is granulated by a dry granulator without adding water into granulated powder which may be tableted when tablets are to be produced. In a fluidized bed granulating/drying method which is one of wet granulating methods, raw material powder is sprayed with an aqueous solution of binder such as α-starch and is granulated and dried into granulated powder which may be tableted when tablets are to be produced. In the wet granulating method, cleaning of the production equipments is troublesome since gliadin, when wetted, becomes viscous to have adhesivity. Thus, a dry granulating method, which requires no water as binder solution, is particularly preferable as the granulating method for the functional masticatory product of the invention. Meanwhile, when a functional masticatory product with high moisture content in the form of wet mass is produced, water is added to the raw material power of gliadin and the like by 15-25% upon kneading, so that the wet mass becomes extremely viscous and involves a lard load during the kneading, and thus a large-scale and high-powered kneader is required as is used for production of chewing gum base. Further, in order to thinly stretch and cut such wet mass, special equipments such as two- or three-high rolling rollers and cutting rollers are required as are used for production of chewing gum. When tablets are produced by tableting the granulated powder obtained by hot-air drying and pulverizing the functional masticatory product with high moisture content in the form of wet mass, a drying operation take a long time because of high viscosity of the wet mass and moldability of the product is poor upon tableting because of hardness in the obtained granulated powder, which make it difficult to produce the tablets efficiently and, of course, results in substantial increase in production cost. Meanwhile, where the functional masticatory product with high moisture content in the form of wet mass is freeze-dried, a drying operation takes as long as more than two days and is extremely troublesome in that as many as hundreds of thousand of small wet mass plates about 10 mm square are housed in a lyophilizer. Thus, the production cost is remarkably increased compared with the method of production of the invention which can ensure the production of more than one million tablets per day.

According to the invention, even lactic acid bacteria and/or enzyme readily affected by moisture may be combined since the tableting or granulating is conducted under a condition of low moisture activity. In a formulation with water insoluble solid functional components, e.g., inorganic compounds such as dolomite, a base material ratio of prolamine/wheat gluten and/or a combined amount of polyphenol is controlled to have mastication time of several minutes to about 10 minutes; alternatively, the claimed masticatory product may be adjusted to be smaller size to have a weight of 300-400 mg per tablet, which allows the tablets to be readily swallowed. Thus, functional components contained in the masticatory product can be ingested reliably and sufficiently.

As recited in claim 21 of the invention, when in claim 15, 17 or 18, proteolytic enzyme agent is combined by 1-40%, the functional masticatory product can be produced which has adjusted mastication time.

As recited in claim 22 of the invention, when in claim 15, 17 or 18, disintegrant aid is combined by 5-40%, the masticatory product can be produced which has adjusted mastication time.

Next, a method of using a functional masticatory product of the invention will be described.

Claim 23 in the invention is directed to a method of using a functional masticatory product wherein the functional masticatory product as claimed in any one of claims 1-8 and 10 is masticated and a functional masticatory product as claimed in claim 11 is additionally masticated.

Claim 24 of the invention is directed to a method of using a functional masticatory product wherein a functional masticatory product as claimed in claim 9 is masticated and a functional masticatory product as claimed in claim 11 is additionally masticated.

Claim 25 of the invention is directed to a method of using a masticatory product wherein the functional masticatory product as claimed in any one of claims 1-8 and 10 with mastication time of more than 10 minutes is masticated and then a solid masticatory product or a functional masticatory product with mastication time of less than 2 minutes is newly added and masticated.

Claim 26 of the invention is directed to a method of using a functional masticatory product wherein the functional masticatory product as claimed in claim 9 with mastication time of more than 10 minutes is masticated and a solid masticatory product or a functional masticatory product with mastication time of less than 2 minutes is newly added and masticated.

Claim 27 of the invention is directed to the fact that, in claim 25 or 26 wherein the solid masticatory product is composed of prolamine or has a weight ratio of prolamine to wheat gluten in a range of 9.9:0.1-8.1:1.9.

Claim 28 of the invention is directed to a method of using a functional masticatory product wherein the functional masticatory product as claimed in any one of claims 1-8 and 10 with mastication time of more than 10 minutes is masticated and a tablet of organic acid is additionally masticated.

Claim 29 of the invention is directed to a method of using a functional masticatory product wherein the functional masticatory product as claimed in claim 9 with mastication time of more than 10 minutes is masticated and a tablet of organic acid is additionally masticated.

Claim 30 of the invention is directed to the fact that, in claim 28 or 29, the organic acid is at least one selected from a group consisting of citric acid, malic acid, dihydroxysuccinic acid, succinic acid, gluconic acid, lactic acid and acetic acid.

Claim 31 of the invention is directed to a method of using a functional masticatory product wherein the functional masticatory product as claimed in any one of claims 1-8 and 10 with mastication time of more than 10 minutes is masticated and a rapid disintegrant tablet is newly added and masticated.

Claim 32 of the invention is directed to a method of using a functional masticatory product wherein the functional masticatory product as claimed in claim 9 with mastication time of more than 10 minutes is masticated and a rapid disintegrant tablet is newly added and masticated.

Claim 33 of the invention is directed to the fact that, in claim 31 or 32, the rapid disintegrant tablet contains at lest one selected from a group consisting of organic acids such as citric acid, malic acid, dihydroxysuccinic acid, succinic acid, gluconic acid, lactic acid, acetic acid and ascorbic acid, proteins such as gelatin, sodium caseinate and collagen, polysaccharides such as carageenan, xanthan gum, gellan gum, tragacanth, agar, sodium carboxymethylcellulose, calcium carboxycellulose and sodium alginate, polyglutamine, arginine, cocoa powder and butter milk powder.

As recited in claim 23 of the invention, when the functional masticatory product as claimed in any one of claims 1-8 and 10 is masticated and the functional masticatory product as claimed in claim 11 is additionally masticated, then the masticatory products become readily loosenable because of resultant reduced elasticity and aggregateness due to the proteolytic enzyme agent as claimed in claim 11, thereby shortening the mastication time. Thus, the mastication time can be controlled depending on a masticator's preference, which accordingly facilitates edibility of the functional masticatory products to thereby further appropriately contribute to preservation, promotion or regaining of health and concurrently to treatment of diseases.

As recited in claim 24 of the invention, when the functional masticatory product as claimed in claim 9 is masticated and a functional masticatory product as claimed in claim 11 is additionally masticated, then the masticatory products become readily loosenable because of resultant reduced elasticity and aggregateness due to the proteolytic enzyme agent as claimed in claim 11, thereby shortening the mastication time. Thus, the mastication time can be controlled depending on a masticator's preference, which accordingly facilitates edibility of the functional masticatory products to thereby further appropriately contribute to preservation, promotion or regaining of health and concurrently to treatment of diseases.

As recited in claim 25 of the invention, when the functional masticatory product as claimed in any one of claims 1-8 and 10 with the mastication time of more than 10 minutes is masticated and a solid masticatory product or a functional masticatory product with mastication time of less than 2 minutes is newly added and masticated, then the masticatory product become readily loosenable because of resultant reduced elasticity and aggregateness due to change of the ratio with respect to the prolamine or to the polyphenol therein by the masticatory product having mastication time of less than 2 minutes, thereby shortening the mastication time. Thus, the mastication time can be controlled depending on a masticator's preference. As a result, high masticatory performance and easy edibility can be well-balanced in the functional masticatory product to thereby further appropriately contribute to preservation, promotion or regaining of health and treatment of diseases. More specifically, for example in a sleep averting product for drivers, a tablet containing caffeine with enough toughness of having mastication time of more than 30 minutes is firstly masticated for a preferable time period, e.g., about 30 minutes and when being bored in mastication, a tablet with vitamins and having mastication time of less than 2 minutes is additionally masticated, so that the masticatory products loosen within a few minutes because of reduced elasticity and aggregateness and become readily swallowable even if the masticator is a female.

As recited in claim 26 of the invention, when the functional masticatory product as claimed in claim 9 with mastication time of more than 10 minutes is masticated and a solid masticatory product or a functional masticatory product with mastication time of less than 2 minutes is newly added and masticated, then the masticatory products become readily loosenable because of reduced elasticity and aggregateness due to change of the ratio to the prolamine or to the polyphenol by the masticatory product having mastication time of less than 2 minutes, thereby shortening the mastication time. Thus, the mastication time can be controlled depending on a masticator's preference. As a result, high masticatory performance and easy edibility can be well-balanced in the functional masticatory product to thereby further appropriately contribute to preservation, promotion or regaining of health and treatment of diseases. More specifically, for example in a sleep averting product for drivers, a tablet containing caffeine with enough toughness to have mastication time of more than 30 minutes is firstly masticated for a preferable time period, e.g., about 30 minutes and when being bored in mastication, a tablet containing vitamins and having mastication time of less than 2 minutes is additionally masticated. Then, the masticatory products loosen within a few minutes because of reduced elasticity and aggregateness and become readily swallowable even if the masticator is a female.

As recited in claim 27 of the invention, when in claim 25 or 26, solid masticatory product is composed of prolamine or has a weight ratio of prolamine to wheat gluten in a range of 9.9:0.1-8.1:1.9, then the masticatory product becomes readily loosenable because of reduced elasticity and aggregateness by readily changing the ratio to prolamine or to polyphenol, thereby shortening the mastication time and thus facilitating edibility of the functional masticatory product.

As recited in claim 28 of the invention, when the functional masticatory product as claimed in any one of claims 1-8 and 10 with mastication time of more than 10 minutes is masticated and a tablet of organic acid is additionally masticated, the masticatory product become readily loosenable because of reduced elasticity and aggregateness due to components in the tablet of organic acid, thereby shortening the mastication time. Thus, the mastication time can be controlled depending on a masticator's preference. As a result, high masticatory performance and easy edibility can be well-balanced in the functional masticatory product to thereby further appropriately contribute to preservation, promotion and regaining of health and treatment of disease.

As recited in claim 29 of the invention, when the functional masticatory product as claimed in claim 9 with mastication time of more than 10 minutes is masticated and a tablet of organic acid is additionally masticated, the masticatory product becomes readily loosenable because of resultant reduced elasticity and aggregateness due to components in the tablet of organic acid, thereby shortening the masticator time. Thus, the mastication time can be controlled depending on a masticator's preference. As a result, high masticatory performance and easy edibility can be well-balanced in the functional masticatory product to thereby further appropriately contribute to preservation, promotion and regaining of health and treatment of disease.

As recited in claim 30 of the invention, when, in claim 28 or 29, the organic acid is at least one selected from a group consisting of citric acid, malic acid, dihydroxysuccinic acid, succinic acid, gluconic acid, lactic acid and acetic acid, the masticatory product becomes readily loosenable because of resultant reduced elasticity and aggregateness. Thus, the mastication time can be controlled to facilitates edibility of the functional masticatory product.

As recited in claim 31 of the invention, when the functional masticatory product as claimed in any one of claims 1-8 and 10 with mastication time of more than 10 minutes is masticated and a rapid disintegrant tablet is newly added and masticated, then the masticatory product becomes readily loosenable because of resultant reduced elasticity and aggregateness due to components in the rapid disintegrant tablet, thereby shortening the mastication time. Thus, the mastication time can be controlled depending on a masticator's preference. As a result, high masticatory performance and easy edibility can be well-balanced in the functional masticatory product to thereby further appropriately contribute to preservation, promotion and regaining of health and treatment of diseases. More specifically, for example in a sleep averting product for drivers, a tablet containing caffeine with enough toughness of having mastication time of more than 30 minutes is firstly masticated for a preferable time period, e.g., about 30 minutes and when being bored in mastication, a rapid disintegrant tablet with vitamins is additionally masticated. Then, the masticatory products loosen within a few minutes because of resultant reduced elasticity and aggregateness and become swallowable even if the masticator is a female.

As recited in claim 32 of the invention, when the functional masticatory product as claimed in claim 9 with mastication time of more than 10 minutes is masticated and a rapid disintegrant tablet is newly added and masticated, then the masticatory product becomes readily loosenable because of resultant reduced elasticity and aggregateness due to components in the rapid disintegrant tablet, thereby shortening the mastication time. Thus, the mastication time can be controlled depending on a masticator's preference. As a result, high masticatory performance and easy edibility can be well-balanced in the functional masticatory product to thereby further appropriately contribute to preservation, promotion or regaining of health and treatment of diseases. More specifically, for example in a sleep averting product for drivers, a tablet containing caffeine with enough toughness of having mastication time of more than 30 minutes is firstly masticated for a preferable time period, e.g., about 30 minutes and when being bored in mastication, a rapid disintegrant tablet containing vitamins is additionally masticated. Then, the masticatory products loosen within a few minutes because of reduced elasticity and aggregateness and become swallowable even if the masticator is a female.

As recited in claim 33 of the invention, when, in claim 31 or 33, the rapid disintegrant tablet is composed of at least one selected from a group consisting of organic acids such as citric acid, malic acid, tartaric acid, succinic acid, gluconic acid, lactic acid, acetic acid and ascorbic acid, proteins such as gelatin, sodium caseinate and collagen, polysaccharides such as carageenanan, xanthan gum, gellan gum, tragacanth, agar, sodium carboxymethylcellulose, calcium carboxycellulose and sodium alginate, polyglutamine, arginine, cocoa powders and butter milk powders, the masticatory product becomes readily loosenable because of resultant reduced elasticity and aggregateness. Thus, the mastication time period can be controlled to facilitate edibility of the functional masticatory product.

### EFFECTS OF THE INVENTION

Mastication of a functional masticatory product according to the invention brings about various effects and advantages. The mastication time can be prolonged in comparison with gummi candy to increase a number of mastication. A functional material or materials can be ingested without discarding the same due to their edibility to thereby properly contribute to preservation, promotion or regaining of health and simultaneously to treatment of diseases. Environmental pollution by discard after mastication like chewing gum can be prevented since the functional masticatory product has edibility.

### BRIEF DESCRIPTION OF THE DRAWINGS

FIG. 1 is a graph showing a result in Example 4 of the invention.

### BEST MODE FOR CARRYING OUT THE INVENTION

There are following Examples.

### Example 1

In Example 1, gliadin (gliadin fraction) as prolamine, active or vital gluten as wheat gluten, xylitol as functional material and calcium stearate as lubricant were combined. Examined by the following model formulations was how a ratio of gliadin to gluten affected moldability upon tableting and physical properties, i.e., mastication time (minutes), elasticity and extensibility of a functional masticatory product. Tablets each having a diameter of about 15 mm, a weight of about 1000 mg and hardness of about 4 to 5 kg/cm² were made using a static compressor, and each evaluation parameter was evaluated as follows.

### (1) Moldability

The tablet hardness was measured.
Good: having hardness of about 4-5 kg/cm² or more;
Fair: having hardness of about 3 kg/cm²; and
Bad: having hardness of about 2 kg/cm² or less and being easily breakable even if tableted and hard to deal with as tablets.

### (2) Physical Properties

### (a) Mastication Time

A tablet of functional masticatory product was masticated at a rate of 70 to 80 times per minute and the time period until the functional masticatory product loosened to be swallowed was measured as mastication time (minutes). The wording “15 or more” means that the functional masticatory product kept a certain mass without loosening even after mastication of 15 minutes.

### (b) Elasticity

Examined was a status of the functional masticatory product about 2 minutes before the mastication time evaluation or 10 minutes after beginning of mastication.

Very Good: forming a tough gum-like mass with strong elasticity;
Good: forming a slightly soft gum-like mass; and
Fair: forming a mass having slight elasticity and nearly loosening.

### (c) Extensibility

About 2 minutes before the mastication time evaluation or 10 minutes after beginning of mastication, the masticatory product was held between teeth and extended with fingers to examine a status thereat.

Very Good: extensible by 10 cm or more;
Good: extensible by about 5 cm;
Fair: extensible by about 3 cm; and
Bad: extensible by 1 cm or less or not extensible.

TABLE 1

| | No. of Experiment | | | | | | | | | | |
|---|---|---|---|---|---|---|---|---|---|---|---|
| | 01 | 02 | 03 | 04 | 05 | 06 | 07 | 08 | 09 | 10 | 11 |
| gliadin/gluten | 10/0 | 9/1 | 8/2 | 7/3 | 6/4 | 5/5 | 4/6 | 3/7 | 2/8 | 1/9 | 0/10 |
| gliadin fraction (g) | 4.0 | 3.6 | 3.2 | 2.8 | 2.4 | 2.0 | 1.6 | 1.2 | 0.8 | 0.4 | 0 |
| vital gluten (g) | 0 | 0.4 | 0.8 | 1.2 | 1.6 | 2.0 | 2.4 | 2.8 | 3.2 | 3.6 | 4.0 |
| xylitol (g) | 2 | 2 | 2 | 2 | 2 | 2 | 2 | 2 | 2 | 2 | 2 |
| calcium stearate | 0.06 | 0.06 | 0.06 | 0.06 | 0.06 | 0.06 | 0.06 | 0.06 | 0.06 | 0.06 | 0.06 |
| moldability | Good | Good | Good | Good | Good | Good | Good | Good | Fair | Bad | Bad |
| mastication time | 1.5 | 2.5 | 4 | 5.5 | 8 | 15 or | 15 or | 15 or | 15 or | 15 or | 15 or |
| (min.) | | | | | | more | more | more | more | more | more |
| elasticity | Good | Good | Good | Good | Good | Good | Good | Good | Fair → | Fair → | Fair → |
| | | | | | | | | | Good | Good | Good |
| extensibility | — | — | Very | Very | Very | Very | Very | Good | Fair | Bad | Bad |
| | | | Good | Good | Good | Good | Good | | | | |

—: Because of short mastication time, extensibility is difficult to evaluate.

As is known from the above results, the mastication time is too short when the ratio of gliadin fraction/active gluten is 10/0 (experiment No. 01) or 9/1 (experiment No. 02). A tablet is difficult to mold when the ratio of the gliadin fraction/active gluten is 1/9 (experiment No. 10) or 0/10 (experiment No. 11). It is thus evident that the functional masticatory product in the form of tablets is obtained when the ratio of gliadin fraction/active gluten is within a range from 8/2 (experiment No. 03) to 2/8 (experiment No. 09), the weight ratio of prolamine to wheat gluten being within a range of 8:2 to 2:8.

### Example 2

In Example 2, to gliadin (gliadin fraction) as prolamine and active or vital gluten as wheat gluten, tea catechin as polyphenol was combined in an amount of 0.20 g. Just like Example 1, examined by the following model formulations was how tea catechin as polyphenol affected the moldability upon tableting and the physical properties, i.e., mastication time (minutes), elasticity and extensibility of the functional masticatory product. The tea catechin had total polyphenol content of 90.4% and epigallocatechin gallate (EGCg) content of 47.4%.

TABLE 2

| | No. of Experiment | | | | | | | | | | |
|---|---|---|---|---|---|---|---|---|---|---|---|
| | 21 | 22 | 23 | 24 | 25 | 26 | 27 | 28 | 29 | 30 | 31 |
| gliadin/gluten | 10/0 | 9/1 | 8/2 | 7/3 | 6/4 | 5/5 | 4/6 | 3/7 | 2/8 | 1/9 | 0/10 |
| gliadin fraction (g) | 4.0 | 3.6 | 3.2 | 2.8 | 2.4 | 2.0 | 1.6 | 1.2 | 0.8 | 0.4 | 0 |
| vital gluten (g) | 0 | 0.4 | 0.8 | 1.2 | 1.6 | 2.0 | 2.4 | 2.8 | 3.2 | 3.6 | 4.0 |
| tea catechin (g) | 0.2 | 0.2 | 0.2 | 0.2 | 0.2 | 0.2 | 0.2 | 0.2 | 0.2 | 0.2 | 0.2 |
| xylitol (g) | 2 | 2 | 2 | 2 | 2 | 2 | 2 | 2 | 2 | 2 | 2 |
| calcium stearate (g) | 0.06 | 0.06 | 0.06 | 0.06 | 0.06 | 0.06 | 0.06 | 0.06 | 0.06 | 0.06 | 0.06 |
| moldability | Good | Good | Good | Good | Good | Good | Good | Good | Fair | Bad | Bad |
| mastication time | 15 or | 15 or | 15 or | 15 or | 15 or | 15 or | 15 or | 15 or | 15 or | Muddy | Muddy |
| (min.) | more | more | more | more | more | more | more | more | more | | |
| elasticity | Good | Good | Very | Very | Very | Very | Very | Very | Very | | |
| | | | Good | Good | Good | Good | Good | Good | Good | | |
| extensibility | Very | Very | Very | Very | Very | Very | Very | Very | Very | | |
| | Good | Good | Good | Good | Good | Good | Good | Good | Good | | |

Muddy: When a tablet is masticated, it instantly breaks up into sludge through inclusion of saliva.

As is clear from the above, even in base material compositions (experiment Nos. 21 to 25) with greater gliadin fraction ratio or gliadin fraction/vital gluten=10/0 to 6/4, the masticatory products with mastication time of 15 minutes or more and abundant in elasticity and extensibility were obtained since proteins in the gliadin fraction were aggregated and assembled by the polyphenol (tea catechin). Also in other compositions, the elasticity was enhanced. In the base material composition with 10% of gliadin fraction or only with vital gluten (experiment number 30 or 31), no physical property improvement was observed due to protein aggregation action of tea catechin, nor enhanced was moldability of the tablet. Furthermore, the base material compositions which could be utilized as the functional masticatory product were those with gliadin fraction/vital gluten in a range of 10/0 to 2/8.

As a result, it is apparent that, in a case where polyphenol was combined by 5% (tea catechin: 0.20 g) to a total amount (4.0 g) of prolamine and wheat gluten, the functional masticatory products were obtained without problems when a ratio of gliadin fraction/active gluten was in a range of 10/0 to 2/8, the weight ratio of prolamine to wheat gluten being in a range of 9.9:0.1 to 2:8.

### Example 3

In Example 3, to gliadin (gliadin fraction) as prolamine and active or vital gluten as wheat gluten, tea catechin as polyphenol was combined in an amount of 0.10 g. Just like Examples 1 and 2, examined by the following model formulations was how tea catechin as polyphenol affected the moldability upon tableting and physical properties, i.e., mastication time (minutes), elasticity and extensibility of the functional masticatory product. The tea catechin had total polyphenol content of 90.4% and epigallocatechin gallate (EGCg) content of 47.4%.

TABLE 3

| | No. of Experiment | | | | | | | | | | | |
|---|---|---|---|---|---|---|---|---|---|---|---|---|
| | 41 | 42 | 43 | 44 | 45 | 46 | 47 | 48 | 49 | 50 | 51 | 52 |
| gliadin/gluten | 10/0 | 9/1 | 8.5/1.5 | 8/2 | 7/3 | 6/4 | 5/5 | 4/6 | 3/7 | 2/8 | 1/9 | 0/10 |
| Gliadin fraction (g) | 4.0 | 3.6 | 3.4 | 3.2 | 2.8 | 2.4 | 2.0 | 1.6 | 1.2 | 0.8 | 0.4 | 0 |
| vital gluten(g) | 0 | 0.4 | 0.6 | 0.8 | 1.2 | 1.6 | 2.0 | 2.4 | 2.8 | 3.2 | 3.6 | 4.0 |
| tea catechin (g) | 0.1 | 0.1 | 0.1 | 0.1 | 0.1 | 0.1 | 0.1 | 0.1 | 0.1 | 0.1 | 0.1 | 0.1 |
| xylitol (g) | 2 | 2 | 2 | 2 | 2 | 2 | 2 | 2 | 2 | 2 | 2 | 2 |
| calcium stearate (g) | 0.06 | 0.06 | 0.06 | 0.06 | 0.06 | 0.06 | 0.06 | 0.06 | 0.06 | 0.06 | 0.06 | 0.06 |
| moldability | Good | Good | Good | Good | Good | Good | Good | Good | Good | Fair | Bad | Bad |
| mastication time | 4 | 7 | 10 | 15 or | 15 or | 15 or | 15 or | 15 or | 15 or | 15 or | Muddy | Muddy |
| (min.) | | | | more | more | more | more | more | more | more | | |
| elasticity | Good | Good | Good | Good | Very | Very | Very | Very | Very | Very | | |
| | | | | | Good | Good | Good | Good | Good | Good | | |
| extensibility | Very | Very | Very | Very | Very | Very | Very | Very | Very | Good | | |
| | Good | Good | Good | Good | Good | Good | Good | Good | Good | | | |

As is clear from the above, when the tea catechin was combined by 0.10 g which was half the amount in Example 2, the base material composition (experimental Nos. 41-43) with higher gliadin fraction ratio had shorter mastication time of less than 10 minutes and rather lowered elasticity so that a masticatory product with not too long mastication time was obtained. Furthermore, the base material compositions which could be utilized as the functional masticatory product were those with gliadin fraction/vital gluten in a range of 10/0 to 2/8.

As a result, it is apparent that, in a case where polyphenol was combined by 2.5% (tea catechin: 0.10 g) to a total amount (4.0 g) of prolamine and wheat gluten, the functional masticatory products were obtained without problems when a ratio of gliadin fraction/active gluten was in a range of 10/0 to 2/8, the weight ratio of prolamine to wheat gluten being in a range of 9.9:0.1-2:8.

It is apparent from the results of Examples 1-3 that base material composition (ratio of gliadin fraction/active gluten) and combined amount of polyphenol such as tea catechin are involved as factors affecting on physical properties of the functional masticatory product.

### Example 4

Examined in Example 4 were elution behaviors of the functional components when the functional masticatory product of the invention was masticated. Caffeine and vitamin E (tocopherol acetate) were selected as water soluble and fat-soluble matters, respectively. As model formulations, the raw materials in Table 4 and 5 were tableted to obtain tablets each with a diameter of 13 mm and a weight of 0.6 g.

TABLE 4

| material | combined amount (g) |
|---|---|
| prolamine (gliadin) | 48.0 |
| wheat gluten (vital gluten) | 12.0 |
| polyphenol (tea catechin) | 4.0 |
| functional materials (inulin, | 29.5 |
| caffeine and xylitol) | |
| sweetener | 3.0 |
| lubricant, fluid accelerator | 3.5 |

TABLE 5

| material | combined amount(g) |
|---|---|
| prolamine (gliadin) | 48.0 |
| wheat gluten (vital gluten) | 12.0 |
| polyphenol (tea catechin) | 3.5 |
| functional materials (inulin, | 30.5 |
| caffeine and xylitol) | |
| sweetener | 3.0 |
| lubricant, fluid accelerator | 3.0 |

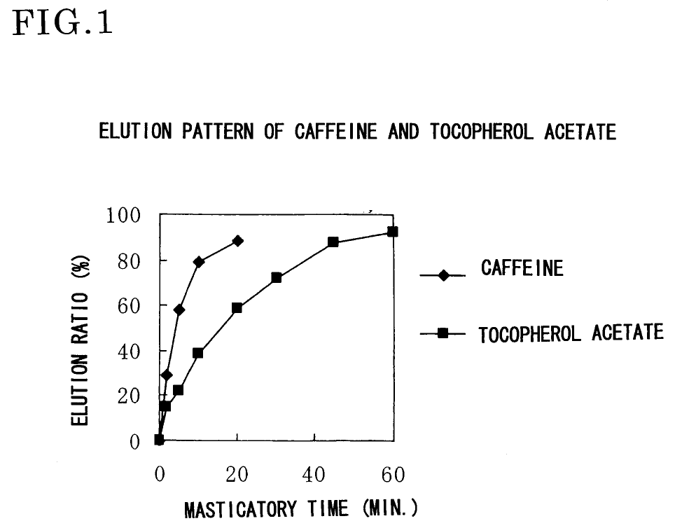

Elution pattern of functional components by mastication was measured as follows. A tablet of masticatory product was masticated for a predetermined time and then washed lightly with water to be weighed. Thus, about 100 g of the washed masticatory product was accurately weighed. Caffeine and tocopherol acetate tablets were pretreated as mentioned below to prepare sample solutions; respective components were quantified for obtaining residual ratio (%) from which elution ratio was calculated using (100−residual ratio(%)), thus determining elution pattern. Results are shown in FIG. 1.

Caffeine Tablets:

The masticatory product washed with water and precisely weighed by about 100 mg was mashed in a mortar with adding an aqueous solution of 0.02 N sodium hydroxide in 30% methanol to dissolve therein. The solution was added with 6 mL of 0.2 N hydrochloric acid and water and a total volume was made to 50 mL. The solution was centrifuged (at 3000 rpm for 5 minutes) to obtain supernatant as sample solution. Using the sample solution, caffeine was quantified through high-performance liquid chromatography. At the mastication time of 0, 2, 5, 10 and 20 minutes, respectively, each experiment was repeated three times and caffeine left in the masticatory product was quantified. A residual ratio (%) was calculated from a mean of the three times and an elution ratio (%) was calculated therefrom to obtain an elution pattern.

Tocopherol Acetate Tablets:

The masticatory product washed with water and precisely weighed by about 100 mg was mashed in a mortar with adding an aqueous solution of 0.02 N sodium hydroxide in 30% methanol to dissolve therein, and a total volume was made to 50 mL. This solution in an amount of 10 mL was added with 90% ethanol and the mixture was shaken for 5 minutes, and then the total volume was made to 50 mL. Subsequently the resulting solution was sonicated for 10 minutes and then centrifuged (3000 rpm for 5 minutes) to obtain a supernatant as sample solution. Tocopherol acetate was quantified using the sample solution by high-performance liquid chromatography; more specifically, since tocopherol acetate may be partly converted into tocopherol during the preparation of the sample solution, both tocopherol acetate and tocopherol were quantified and the both in mole numbers were summed to obtain the amount of tocopherol acetate. At the mastication time of 0, 2, 5, 10, 20, 30, 45 and 60 minutes, respectively, each experiment was repeated three times and tocopherol acetate left in the masticatory product was quantified. A residual ratio (%) was calculated from a mean of the three times and an elution ratio (%) was calculated therefrom to obtain an elution pattern.

As was evident from FIG. 1, caffeine, which was a water-soluble substance, was eluted by about 80% at mastication time of 10 minutes and by about 90% at mastication time of 20 minutes. Meanwhile, tocopherol acetate, which was a lipid-soluble substance, was eluted by about 40% at mastication time of 10 minutes, by about 60% at 20 minutes, 70% at 30 minutes, a little under 90% at 45 minutes and over 90% at 60 minutes, but the elution of tocopherol acetate was slower than that of caffeine. It is, thus, evident that the functional components in the functional material or materials can be ingested by mastication.

In Example 5, it was ascertained that, when eaten through mastication, the functional masticatory product of the invention was completely digested in the digestive organs. Tablets each with a diameter of 13 mm and a weight of 0.6 g were obtained by tableting using the materials in Table 6.

Digestion experiments on human were performed as follows. One or two tablets after every meal, 5 tablets per day and totally 15 tablets for 3 days were administrated to each of 8 volunteers. Total feces of the volunteers were collected on a daily basis for 5 days from the 2nd day during the administration to the 3rd day after the administration. The feces were minutely examined to observe whether white masses derived from the masticatory products were excreted in the feces or not. As a result, no undigested white masses derived from the masticatory products were found in the feces of the eight volunteers.

It was also ascertained that the functional masticatory product was digested in an artificial gastric fluid composed of pepsin derived from swine gastric mucosa and an artificial intestinal fluid composed of pancreatin derived from swine pancreas. Thus, it is evident that the functional masticatory product has edibility and is completely digested in the digestive organs and that the functional components in the functional material or materials can be reliably absorbed.

TABLE 6

| material | combined amount (g) |
|---|---|
| prolamine (gliadin) | 48.0 |
| wheat gluten (vital gluten) | 12.0 |
| polyphenol (tea catechin) | 3.3 |
| functional materials (inulin, | 25.0 |
| ascospore acidophilus and | |
| bifidobacteria) | |
| sweetener | 3.0 |
| colorant (titanium oxide) | 3.0 |
| flavor | 3.0 |
| lubricant, fluid accelerator | 2.7 |

### Example 6

Example 6 is a first example of a functional masticatory product composed of gliadin as prolamine, vital gluten as wheat gluten, tea catechin as polyphenol and functional materials and the mastication time and the effects of the functional materials were ascertained. In the method of production, gliadin, vital gluten, tea catechin and xylitol were placed in a stirring granulator, and mastic oil, nutmeg extract and tansy extract were sequentially added with stirring. Then, the mixture was transferred to a fluidized bed granulator/drier, sprayed by an aqueous solution of 3% α-starch with dissolved sweetener, and then granulated and dried. Parameters for fluidized bed granulation are shown in Table 7.

TABLE 7
Fluidized bed granulation parameters

| | |
|---|---|
| intake temperature | 90° C. |
| exhaust temperature | 40° C. |
| intake airflow rate | 5 m³/minute |
| sprayed liquid volume | 120 mL/minute |
| sprayed air pressure | 1.2 kg/cm² |
| drying temperature | 42° C. |

Then, the obtained granulated powder was added with flavor and lubricant in ratios shown in Table 8 below. The mixture was tableted into tablets each having a diameter of 13 mm and a weight of 0.7 g.

TABLE 8

| material | combined amount (g) |
|---|---|
| prolamine (gliadin) | 5200.0 |
| wheat gluten (vital gluten) | 1300.0 |
| polyphenol (tea catechin) | 300.0 |
| functional materials (mastic oil, | 2607.0 |
| nutmeg extract, tansy extract and | |
| xylitol) | |
| binder (α-starch) | 150.0 |
| sweetener | 43.0 |
| flavor | 250.0 |
| lubricant | 150.0 |

The functional masticatory product obtained as mentioned above was masticated at a rate of 70-80 times per minute and eating quality with elasticity and aggregateness could be kept for 15 minutes.

In order to evaluate an intraoral cleaning action as functionality of the functional masticatory product obtained in Example 6, a mouth odor before and after masticating a piece of functional masticatory product was measured using an intraoral gas detector. Before administering the functional masticatory product, 60 ppm of ammonia was detected in breath, but the concentration of ammonia detected after mastication for 15 minutes was 10 ppm or less. This reveals that the functional masticatory product obtained in Example 6 has a cleaning action to substantially reduce intraoral bacteria and it is evident that the functional masticatory product cleans an intraoral environment.

### Example 7

Example 7 is a second example of the functional masticatory product composed of gliadin as prolamine, grape seed proanthocyanidine as polyphenol and functional materials and the mastication time and the effects of the functional materials were ascertained. In the method of production, the mixed raw material powder shown in Table 9 below was supplied to a dry granulator to obtain granulated powder having a mean particle diameter of about 500μ and a bulk specific volume of 1.8 mL/g. Subsequently, tablets each having a diameter of 15 mm and a weight of 1 g were made.

TABLE 9

| material | combined amount (g) |
|---|---|
| prolamine (gliadin) | 2800.0 |
| polyphenol (grape seed | 150.0 |
| proanthocyanidin) | |
| functional materials (dolomite | 1855.0 |
| (mineral), multi-vitamin mix | |
| (vitamin), ferric pyrophosphate, | |
| zinc yeast, isoflavone and inulin) | |
| sweetener | 20.0 |
| flavor | 125.0 |
| lubricant | 50.0 |

The functional masticatory product obtained as mentioned above was masticated at a rate of 70-80 times per minute and eating quality with elasticity and aggregateness could be kept for 7 minutes.

The functional masticatory product obtained in Example 7, in which minerals and vitamins are combined, has the effect for middle aged people and diet-oriented females who are liable to lack them. Since isoflavone having a female hormone like physiological action is combined, it can be suitably applied to females in a wide range of age groups from the young to the elderly.

### Example 8

Example 8 is a third example of the functional masticatory product composed of gliadin as prolamine, vital gluten as wheat gluten and functional materials and the mastication time and the effects of the functional materials were ascertained. In the method of production, substantially similarly to Example 6, gliadin, vital gluten, ginkgo leaf (Ginkgo Biloba) extract powder, tea catechin and zinc yeast were placed in a stirring granulator, and DHA oil and EPA oil were sequentially added with stirring. Then, the mixture, lactoferrin and inulin were transferred to the fluidized bed granulator/drier, sprayed by an aqueous solution of 3% α-starch with dissolved sweetener, and then granulated and dried. The resulting granulated powder was added with flavor and the lubricant at ratios shown in Table 10 below and the mixture was tableted to obtain tablets each having a diameter of 13 mm and a weight of 0.7 g.

TABLE 10

| material | combined amount (g) |
|---|---|
| prolamine (gliadin) | 5400.0 |
| wheat gluten (vital gluten) | 600.0 |
| functional materials (ginkgo leaf | 3335.0 |
| extract powder, phosphatidyl | |
| serine, lactoferrin, tea catechin, | |
| zinc yeast, DHA oil and xylo- | |
| oligosaccharide) | |
| binder (α-starch) | 120.0 |
| sweetener | 45.0 |
| flavor | 400.0 |
| lubricant | 100.0 |

The functional masticatory product obtained in the above was masticated at a rate of 70-80 times per minute and eating quality with elasticity and aggregateness could be kept for 10 minutes.

The functional masticatory product obtained in Example 8, which is composed of ginkgo leaf extract, lactoferrin, DHA and the like, has antidementia, immunity-augment, cancer inhibition, anti-inflammatory, anti-arteriosclerotic and hypolipidemic actions and can be appropriately applied to the elder which are liable to suffer from dementia, cancers, arthritis and arterial sclerosis.

### Example 9

Example 9 is a fourth example of the functional masticatory product composed of gliadin as prolamine, vital gluten as wheat gluten, tea catechin as polyphenol and functional materials and the mastication time and the effects of the functional materials were ascertained. In the method of production, substantially similarly to Example 6, gliadin, vital gluten and tea catechin were placed in a fluidized bed granulator/drier. The mixture was sprayed by an aqueous solution of 3% α-starch and granulated and dried. The resultant granulated powder was added with functional materials, sweetener, flavor and lubricant at ratios shown in Table 11 below and supplied to a dry granulator to obtain granulated powder having an average particle diameter of about 350 mg and a bulk specific volume of 2.0 mL/g. The granulated powder was further tableted to obtain tablets each with a diameter of 13 mm and a weight of 0.65 g.

TABLE 11

| material | combined amount (g) |
|---|---|
| prolamine (gliadin) | 6800.0 |
| wheat gluten (vital gluten) | 1200.0 |
| polyphenol (tea catechin) | 300.0 |
| functional materials (apple phenon, | 2590.0 |
| champignon extract, sodium iron- | |
| chlorophyllin and xylitol) | |
| binder (α-starch) | 105.0 |
| sweetener | 2445.0 |
| flavor | 350.0 |
| lubricant | 210.0 |

The functional masticatory product obtained in the above was masticated at a rate of 70 to 80 times per minute and eating quality with elasticity and aggregateness could be kept for 10 minutes.

The functional masticatory product obtained in Example 9 can be suitably used as an etiquette article for suppressing the mouth odor and faces odor since apple phenon, champignon extract and sodium iron chlorophylin were combined which were odor eliminating functional materials.

### Example 10

Example 10 is a fifth example of the functional masticatory product composed of zein as prolamine, vital gluten as wheat gluten, epigallocatechin gallate as polyphenol and functional materials and the mastication time and the effects of the functional materials were ascertained. In the method of production, substantially similarly to Example 7, the materials shown in Table 12 below were used to produce granulated powder by a dry granulator. The granulated powder was tableted to obtain tablets each with a diameter of 15 mm and a weight of 0.8 g.

TABLE 12

| material | combined amount (g) |
|---|---|
| prolamine (gliadin) | 560.0 |
| wheat gluten (vital gluten) | 1040.0 |
| polyphenol (epigallocatechin | 45.0 |
| gallate) | |
| functional materials (apple phenon, | 1031.0 |
| champignon extract, sodium iron- | |
| chlorophyllin, xylitol and galacto- | |
| oligosaccharide) | |
| sweetener | 12.0 |
| flavor | 70.0 |
| lubricant | 42.0 |

The functional masticatory product obtained in the above was masticated at a rate of 70-80 times per minute and eating quality with elasticity and aggregateness could be kept for 15 minutes.

The functional masticatory product obtained in Example 10 can be suitably used, just like that in Example 9, as an etiquette article for suppressing the mouth odor and faces odor since apple phenon, champignon extract and sodium iron chlorophylin were combined which were odor eliminating functional materials.

### Example 11

Example 11 is a sixth Example of the functional masticatory product composed of gliadin as prolamine, vital gluten as wheat gluten, French maritime pine bark extract liquid as polyphenol and functional materials and the mastication time and effects of the functional materials were ascertained. In the method of production, the materials in Table 13 below were supplied to a dry granulator to obtain granulated powder with mean particle diameter of about 350μ and a bulk specific volume 1.9 mL/g. The granulated powder was tableted to obtain tablets each with a diameter of 15 mm and a weight of 0.85 g.

TABLE 13

| material | combined amount (g) |
|---|---|
| prolamine (gliadin) | 2520.0 |
| wheat gluten (vital gluten) | 280.0 |
| polyphenol (French maritime pine | 200.0 |
| bark extract) | |
| functional materials (Ginkgo Biloba | 890.0 |
| extract, coenzyme Q-10, γ- | |
| aminobutyric acid, astaxanthin and | |
| Vinca minor extract) | |
| sweetener | 860.0 |
| flavor | 200.0 |
| lubricant | 50.0 |

The functional masticatory product obtained in the above was masticated at a rate of 70-80 times per minute and eating quality with elasticity and aggregateness could be kept for 7 minutes.

The functional masticatory product obtained in Example 11 can be suitably applied to the elderly who are in danger of dementia since ginkgo leaf extract, coenzyme Q-10, γ-aminobutyric acid, astaxanthin and Vinca minor extract were combined.

### Example 12

Example 12 is a seventh example of the functional masticatory product composed of gliadin as prolamine, vital gluten as wheat gluten, epigallocatechin gallate as polyphenol and functional materials, and the mastication time and the effects of the functional materials were ascertained. In the method of production, gliadin, vital gluten and epigallocatechin gallate among the materials in Table 14 below were placed in a fluidized bed granulator/drier and, substantially similarly to Example 6, sprayed by an aqueous solution of 3% α-starch and granulated and dried. The resulting granulated powder was added with the functional materials, the sweetener, the flavor and the lubricant at ratios in Table 14 and the mixture was supplied to a dry granulator to make the granulated powder having a mean particle diameter of about mg and a bulk specific volume of 2.2 mL/g. The granulated powder was further tableted to obtain tablets each having a diameter of 15 mm and a weight of 0.8 g.

TABLE 14

| material | combined amount (g) |
|---|---|
| prolamine (gliadin) | 3600.0 |
| wheat gluten (vital gluten) | 2400.0 |
| polyphenol (epigallocatechin | 150.0 |
| gallate) | |
| functional materials (caffeine, | 525.0 |
| blueberry, vitamin B1 and α-lipoic | |
| acid) | |
| binder (α-starch) | 120.0 |
| sweetener | 2760.0 |
| flavor | 300.0 |
| lubricant | 150.0 |

The functional masticatory product obtained in the above was masticated at a rate of 70-80 times per minute and eating quality with elasticity and aggregateness could be kept for 15 minutes.

The functional masticatory product obtained in Example 12 can be suitably used as a sleep-averting article for drivers since caffeine, blueberry and vitamin B1 are combined.

### Example 13

Example 13 is an eighth Example of a functional masticatory produce composed of gliadin as prolamine, vital gluten as wheat gluten, tea catechin as polyphenol and functional materials and the mastication time and the effects of the functional materials were ascertained. In the method of production, the mixed material powder of Table 15 below was supplied to a dry granulator to obtain granulated powder with mean particle diameter of about 500μ and bulk specific volume of 1.8 mL/g. Then, the granulated powder was tableted to obtain tablets each having a diameter of 15 mm and a weight of 0.9 g.

TABLE 15

| material | combined amount (g) |
|---|---|
| prolamine (gliadin) | 2380.0 |
| wheat gluten (vital gluten) | 420.0 |
| polyphenol (tea catechin) | 120.0 |
| functional materials (hyaluronic | 1380.0 |
| acid, apple phenon, coenzyme Q-10, | |
| L-carnitine, isoflavone, Garcinia | |
| cambogia, vitamin C and vitamin E) | |
| sweetener | 1100.0 |
| flavor | 150.0 |
| lubricant | 75.0 |

The functional masticatory product obtained in the above was masticated at a rate of 70-80 times per minute and eating quality with elasticity and aggregateness could be kept for 10 minutes.

The functional masticatory product obtained in Example 13 is suitable as a supplement for females in a wide range of age groups from the young to the elderly who are highly interested in beauty and anti-obesity since hyaluronic acid, apple phenon, coenzyme Q-10 and vitamin C as components for whitening and beautiful skin, L-carnitine and garcinia as anti-obesity components and isoflavone with female hormone-like physiological action were combined.

### Example 14

Example 14 is a ninth Example of a functional masticatory product composed of gliadin as prolamine, vital gluten as wheat gluten, tea catechin as polyphenol and functional materials and the mastication time and effects of the functional materials were ascertained. In the method of production, the mixed material powder as shown in Table 16 below was supplied to a dry granulator to obtain granulated powder with a mean particle diameter of about 500μ and a bulk specific volume of 1.7 mL/g. Then, the granulated powder was tableted to obtain tablets each having a diameter of 15 mm and a weight of 0.9 g.

TABLE 16

| material | combined amount (g) |
|---|---|
| prolamine (gliadin) | 1000.0 |
| wheat gluten (vital gluten) | 1500.0 |
| polyphenol (tea catechin) | 120.0 |
| functional materials (nicotine and | 950.0 |
| xylitol) | |
| sweetener | 1155.0 |
| flavor | 200.0 |
| lubricant | 75.0 |

The functional masticatory product obtained in the above was masticated at a rate of 70-80 times per minute and eating quality with elasticity and aggregateness could be kept for 15 minutes.

The functional masticatory product obtained in Example 14 is suitable as a supplement for an anti-smoking aid since nicotine is combined.

### Example 15

Example 15 is a tenth Example of a functional masticatory product composed of gliadin as prolamine, vital gluten as wheat gluten, tea catechin as polyphenol and functional materials and the mastication time and the effects of the functional materials were ascertained. In the method of production, the materials shown in Table 17 below were supplied to a dry granulator to obtain granulated powder with a mean particle diameter of about 500μ and a bulk specific volume of 1.8 mL/g.

TABLE 17

| material | combined amount (g) |
|---|---|
| prolamine (gliadin) | 1040.0 |
| wheat gluten (vital gluten) | 260.0 |
| polyphenol (tea catechin) | 52.0 |
| functional materials (apple phenon, | 550.0 |
| champignon extract, sodium iron- | |
| chlorophyllin and xylitol) | |
| sweetener | 8.0 |
| flavor | 70.0 |
| lubricant | 20.0 |

0.8 g of the functional masticatory product obtained in the above was masticated at a rate of 70-80 times per minute and eating quality with elasticity and aggregateness could be kept for 15 minutes.

The functional masticatory product obtained in Example 15 is suitably used as an etiquette article for suppressing mouth odor and faces odor since apple phenon, champignon extract and sodium iron chlorophylin as odor eliminating functional materials are combined just like Example 9.

### Example 16

Example 16 is an eleventh Example of a functional masticatory product composed of gliadin as prolamine, vital gluten as wheat gluten, tea catechin as polyphenol and functional materials and the mastication time and effects of the functional materials were ascertained. In the method of production, mixed material powder shown in Table 18 below was supplied to a dry granulator to obtain granulated powder with a mean particle diameter of about 350μ and a bulk specific volume of 1.8 mL/g. Then, the granulated powder was tableted to obtain tablets each having a diameter of 15 mm and a weight of 0.8 g.

TABLE 18

| material | combined amount (g) |
|---|---|
| prolamine (gliadin) | 2400.0 |
| wheat gluten (vital gluten) | 1600.0 |
| polyphenol (tea catechin) | 200.0 |
| functional materials (aspirin and | 2900.0 |
| caffeine) | |
| sweetener | 450.0 |
| acidifier | 150.0 |
| flavor | 100.0 |
| lubricant | 200.0 |

The functional masticatory product obtained in the above was masticated at a rate of 70 to 80 times per minute so that it loosened and could be swallowed at 10 minutes.

The functional masticatory product obtained in Example 16 can be suitably used as an antipyretic analgesic agent which can be administered with no water since aspirin and caffeine are combined.

### Example 17

Example 17 is a twelfth example of the functional masticatory product composed of gliadin as prolamine, vital gluten as wheat gluten, tea catechin as polyphenol and functional materials, and the mastication time and the effects of the functional materials were ascertained. In the method of production, gliadin and vital gluten in Table 19 were placed in a stirring granulator, and mastic oil was sequentially added with stirring. Then the mixture was added with tea catechin, the functional materials other than the mastic oil, the sweetener and one half of a fluid accelerator and the resulting mixed powder was supplied to a dry granulator. The resultant granulated powder was added with crystalline cellulose and the other half of the fluid accelerator and the mixture was tableted to obtain tablets each having a diameter of 15 mm and a weight of 0.8 g.

As in this Example, dry granulated powder with oily matter such as mastic oil used as the functional material has deteriorated moldability upon tableting. Such granulated powder can be suitably tableted when a molding aid such as crystalline cellulose is combined. The amount of the molding aid to be combined is preferably around 10%. Addition of the molding aid in an amount over 15% is not preferable since the masticatory product has reduced extensibility to be soft and have reduced toughness in mastication.

TABLE 19

| material | combined amount (g) |
|---|---|
| prolamine (gliadin) | 800.0 |
| wheat gluten (vital gluten) | 200.0 |
| polyphenol (tea catechin) | 40.0 |
| functional materials (mastic oil, | 270.0 |
| licorice extract powder, tansy | |
| extract powder, xylitol and inulin) | |
| molding aid (crystalline cellulose) | 160.0 |
| sweetener | 50.0 |
| flavor | 50.0 |
| lubricant | 30.0 |

The functional masticatory product in the above was masticated at a rate of 70-80 times per minute and eating quality with elasticity and aggregateness could be kept for 15 minutes.

The functional masticatory product obtained in Example 17 can be suitably used as the intraoral cleaning agent since mastic oil is combined as in the case of Example 6.

### Example 18

Example 18 is a thirteenth example of the functional masticatory product composed of gliadin as prolamine, vital gluten as wheat gluten, tea catechin as polyphenol, a neutral protease preparation derived from Bacillus subtilis as a proteolytic enzyme agent and functional materials and the effects of the proteolytic enzyme agent and the functional materials were ascertained. In the method for production, the raw material mixed powder in Table 20 below was supplied to a dry granulator to obtain granulated powder having a mean particle diameter of about 350μ and a bulk specific volume of 1.9 mL/g. The granulated powder was then tableted to obtain tablets each having a diameter of 15 mm and a weight of 0.9 g.

TABLE 20

| material | combined amount (g) |
|---|---|
| prolamine (gliadin) | 960.0 |
| wheat gluten (vital gluten) | 240.0 |
| polyphenol (tea catechin) | 48.0 |
| grass bacillus-derived neutral | 12.0 |
| protease (proteolytic enzyme agent) | |
| functional materials (apple phenon, | 642.0 |
| champignon extract, sodium iron- | |
| chlorophyllin and xylitol) | |
| sweetener | 8.0 |
| flavor | 70.0 |
| lubricant | 20.0 |

The functional masticatory product obtained in the above was masticated at a rate of 70-80 times per minute and loosened by 5 minutes to be swallowed.

The functional masticatory product obtained in Example 18 is suitably used as an etiquette article for suppressing the mouth odor and the faces odor since apple phenon, champignon extract and sodium iron chlorophylin are combined as odor eliminating functional materials as in the case of Example 9.

### Example 19

Example 19 is a fourteenth example of the functional masticatory product composed of gliadin as prolamine, vital gluten as wheat gluten, tea catechin as polyphenol, gelatin as a disintegrant aid and functional materials and the effects of the disintegrant aid and the functional materials were ascertained. In the method for production, the raw material mixed powder in Table 21 below was supplied to a dry granulator to obtain granulated powder having a mean particle diameter of about 300μ and a bulk specific volume of 2.0 mL/g. The granulated powder was then tableted to obtain tablets each having a diameter of 13 mm and a weight of 0.6 g.

TABLE 21

| material | combined amount (g) |
|---|---|
| prolamine (gliadin) | 2880.0 |
| Wheat gluten (vital gluten) | 720.0 |
| polyphenol (tea catechin) | 200.0 |
| disintegrant aid (gelatin) | 1200.0 |
| functional materials (ascospore | 480.0 |
| acidophilus, bifidobacteria and | |
| inulin) | |
| sweetener | 180.0 |
| flavor | 180.0 |
| lubricant | 160.0 |

The functional masticatory product obtained in the above was masticated at a rate of 70-80 times per minute and loosened by 7 minutes to be swallowed.

The functional masticatory product obtained in Example 19 is suitably used as an antiflatuent since spore bearing lactic acid bacteria and lactic bacteria of bifidobacteria are combined.

### Example 20

Example 20 is a first example of the method of using the functional masticatory product and the effect of the method of using was ascertained. The functional masticatory product used was the same as that in Example 15. The functional masticatory product for additional mastication was that obtained in Example 18 and with the proteolytic enzyme agent.

When a tablet candy of Example 15 was masticated for 5 minutes into a state of gum-like mass with the elasticity and aggregateness, a tablet of functional masticatory product shown in Example 18 was added and masticated. As a result, by the action of the proteolytic enzyme agent in the functional masticatory product of Example 18, the gum-like mass totally loosened after 5 minutes and could be easily swallowed.

### Example 21

Example 21 is a second Example in a method of using a functional masticatory product according to the invention and the effectiveness of the method of using were ascertained. The functional masticatory product used was the same as that in Example 15. The solid masticatory product for additional mastication is that prepared by the following method of production.

In the method for producing the solid masticatory product, the mixed raw material powder in Table 22 below was supplied to a dry granulator to obtain granulated powder having a mean particle diameter of about 500μ and a bulk specific volume of 2.0 mL/g. The granulated powder was then tableted to obtain tablets each having a diameter of 15 mm and a weight of 0.9 g.

TABLE 22

| material | combined amount (g) |
|---|---|
| prolamine (gliadin) | 1800.0 |
| wheat gluten (vital gluten) | 200.0 |
| xylitol | 885.0 |
| sweetener | 10.0 |
| flavor | 75.0 |
| lubricant | 30.0 |

By the above, when a tablet candy of Example 15 was masticated for 5 minutes into a state of gum-like mass having the elasticity and aggregateness, a tablet of solid masticatory product shown in Example 21 was added and masticated. As a result, the gum-like mass loosened after two minutes and could be easily swallowed. In the case of the solid masticatory product alone with no polyphenol combined, the gum-like mass loosened within two minutes.

### Example 22

Example 22 is a third example of the method of using the functional masticatory product and the effect of the method of using was ascertained. The functional masticatory product used was the same as that in Example 15. A rapid disintegrant tablet for additional mastication was a tablet of 700 mg composed of 300 mg of xanthan gum, vitamin B1, fine crystalline cellulose, lactilose and lubricant.

When a tablet candy of Example 15 was masticated for 5 minutes into a state of gum-like mass having the elasticity and aggregateness, a tablet of rapid disintegrant tablet shown in Example 22 was added and masticated. As a result, the gum-like mass loosened after two minutes and could be easily swallowed.

It is to be understood that a functional masticatory product, a method of producing the same and a method of using the same according to the invention is not limited to the above-mentioned examples and that various changes and modifications may be made without leaving the spirit of the invention. For example, any other functional materials may be applied providing that they have components having effectiveness through eating.

### INDUSTRIAL APPLICABILITY

According to a functional masticatory product of the invention, varied mastication time longer than that of gummi candy can be obtained and a functional material or materials can be sufficiently ingested without depending on natures of the same such as water solubility. According to a method of producing a functional masticatory product of the invention, an optimum functional masticatory product can be provided. According to a method of using a functional masticatory product of the invention, mastication time can be controlled.

1-33. (canceled)

34: A functional masticatory product which is prepared from wheat gliadin, wheat gluten and at least a functional material through tableting or granulating, a weight ratio of the wheat gliadin to the wheat gluten being in a range of 8:2-2:8, said product having elasticity and extensibility through inclusion of saliva during mastication, said product being edible and having mastication time longer than that of gummi candy.

35: A functional masticatory product which is prepared from wheat gliadin, wheat gluten, polyphenol and at least a functional material through tableting or granulating, a weight ratio of the wheat gliadin to the wheat gluten being in a range of 9.9:0.1-2:8, the polyphenol being combined by 1-20% to a total amount of the wheat gliadin and wheat gluten, said product have elasticity and extensibility through inclusion of saliva during mastication, said product being edible and having mastication time longer than that of gummi candy, the elasticity and extensibility being improved by the polyphenol.

36: The functional masticatory product as claimed in claim 34, wherein the functional material is at least one selected from a group consisting of polyphenols such as tea catechin, epigallocatechin gallate, grape seed proanthocyanidin and French maritime pine bark extract, sesame lignans, astaxanthin derived from Hematococcus algae, γ-aminobutyric acid, xylitol, mastic (mastiche) extract, propolis, funoran, galenical extracts from nutmeg and tansy, mushroom extracts of Agaricus blazei Murrill, Meshimakobu (Phellinus linteus) and Yamabushitake (Hericium erinaceum), fucoidan, heat-treated lactic acid bacteria powder, lactoferrin, isoflavone, Ginkgo leaf (Ginkgo Biloba) extract, Vinca minor extract, phosphatidyl serine, fish-derived highly unsaturated fatty acids such as arachidonic acid, EPA and DHA, chili pepper powder, raspberry ketone, capsiate, coenzyme Q-10, α-lipoic acid, carnitine chloride, citrus extract, salacia extract, Gymnema sylvestre extract, white kidney bean extract, mulberry leaf extract, vitamins, green and yellow vegetables extract, royal jelly, minerals such as calcium compounds, magnesium compounds, zinc yeast and iron drugs, galenical extracts for nutritional fortification, ceramides, hyaluronic acid, cysteine, cystine, champignon extract, sodium copper chlorophyllin, sodium iron-chlorophyllin, lactic acid bacteria, inulin, fructo-oligosaccharide, galacto-oligosaccharide, xylo-oligosaccharide, nicotine, caffeine and theanine.

37: The functional masticatory product as claimed in claim 35, wherein the functional material is at least one selected from a group consisting of polyphenols such as tea catechin, epigallocatechin gallate, grape seed proanthocyanidin and French maritime pine bark extract, sesame lignans, astaxanthin derived from Hematococcus algae, γ-aminobutyric acid, xylitol, mastic (mastiche) extract, propolis, funoran, galenical extracts from nutmeg and tansy, mushroom extracts of Agaricus blazei Murrill, Meshimakobu (Phellinus linteus) and Yamabushitake (Hericium erinaceum), fucoidan, heat-treated lactic acid bacteria powder, lactoferrin, isoflavone, Ginkgo leaf (Ginkgo Biloba) extract, Vinca minor extract, phosphatidyl serine, fish-derived highly unsaturated fatty acids such as arachidonic acid, EPA and DHA, chili pepper powder, raspberry ketone, capsiate, coenzyme Q-10, α-lipoic acid, carnitine chloride, citrus extract, salacia extract, Gymnema sylvestre extract, white kidney bean extract, mulberry leaf extract, vitamins, green and yellow vegetables extract, royal jelly, minerals such as calcium compounds, magnesium compounds, zinc yeast and iron drugs, galenical extracts for nutritional fortification, ceramides, hyaluronic acid, cysteine, cystine, champignon extract, sodium copper chlorophyllin, sodium iron-chlorophyllin, lactic acid bacteria, inulin, fructo-oligosaccharide, galacto-oligosaccharide, xylo-oligosaccharide, nicotine, caffeine and theanine.

38: The functional masticatory product as claimed in claim 34, wherein the functional material is at least one selected from a group consisting of polyphenol including apple proanthocyanidin, cassis extract and blueberry extract, cyanidin glycoside derived from black beans, curcumin, tetrahydrocurcumin, policosanol, octacosanol, collagen, phytic acid, aspirin, acetaminophen, chloropheniramine dl-maleate, dihydrocodeine phosphate, methylephedrine dl-chloride, tipepidine citrate, lysozyme chloride, senega fluid extract, caffeine, allylisopropylacetyl urea, cetylpyridinium chloride, chlorhexidine hydrochloride, potassium cresolsulfonate, sakura bark, licorice, l-menthol and sodium azulenesulfonate.

39: The functional masticatory product as claimed in claim 35, wherein the functional material is at least one selected from a group consisting of polyphenol including apple proanthocyanidin, cassis extract and blueberry extract, cyanidin glycoside derived from black beans, curcumin, tetrahydrocurcumin, policosanol, octacosanol, collagen, phytic acid, aspirin, acetaminophen, chloropheniramine dl-maleate, dihydrocodeine phosphate, methylephedrine dl-chloride, tipepidine citrate, lysozyme chloride, senega fluid extract, caffeine, allylisopropylacetyl urea, cetylpyridinium chloride, chlorhexidine hydrochloride, potassium cresolsulfonate, sakura bark, licorice, 1-menthol and sodium azulenesulfonate.

40: The functional masticatory product as claimed in claim 35, wherein the polyphenol is at least one selected from a group consisting of catechins, epigallocatechin gallate, proanthocyanidine, anthocyanin, flavonol, isoflavone, sesaminol, quercetin, curcumin and persimmon tannin.

41: The functional masticatory product as claimed in claim 34, wherein a proteolytic enzyme agent is combined by 1-40%.

42: The functional masticatory product as claimed in claim 35, wherein a proteolytic enzyme agent is combined by 1-40%.

43: The functional masticatory product as claimed in claim 41, wherein the proteolytic enzyme agent is selected from a group consisting of proteolytic enzymes derived from filamentous fungi, bacteria, basidiomycete, actinomycete and plants.

44: The functional masticatory product as claimed in claim 42, wherein the proteolytic enzyme agent is selected from a group consisting of proteolytic enzymes derived from filamentous fungi, bacteria, basidiomycete, actinomycete and plants.

45: The functional masticatory product as claimed in claim 34, wherein disintegrant aid is combined by 5-40%.

46: The functional masticatory product as claimed in claim 35, wherein disintegrant aid is combined by 5-40%.

47: The functional masticatory product as claimed in claim 45, wherein the disintegrant aid is selected from a group consisting of proteins such as gelatin, sodium caseinate, calcium caseinate and collagen, polysaccharides such as carageenan, xanthan gum, gellan gum, tragacanth, agar, sodium carboxymethylcellulose, calcium carboxycellulose and sodium alginate, polyvinyl pyrrolidone and glycerin monofatty acid ester.

48: The functional masticatory product as claimed in claim 46, wherein the disintegrant aid is selected from a group consisting of proteins such as gelatin, sodium caseinate, calcium caseinate and collagen, polysaccharides such as carageenan, xanthan gum, gellan gum, tragacanth, agar, sodium carboxymethylcellulose, calcium carboxycellulose and sodium alginate, polyvinyl pyrrolidone and glycerin monofatty acid ester.
